(19) United States
(12) Patent Application Publication
(10) Pub. No.: US 2025/0115430 A1
(43) Pub. Date: Apr. 10, 2025

(54) Automated Robotic Multi-Line Picking Buffer Carousel Station

(71) Applicant: Staples, Inc., Framingham, MA (US)

(72) Inventors: Harsha Amba, Tampa, FL (US); Aum Patel, Tampa, FL (US); Garrett Johnson, Tampa, FL (US)

(21) Appl. No.: 18/908,410

(22) Filed: Oct. 7, 2024

Related U.S. Application Data
(60) Provisional application No. 63/588,210, filed on Oct. 5, 2023.

(51) Int. Cl. B65G 1/137

(52) U.S. Cl. CPC B65G 1/1378; B65G 2209/02

(57) ABSTRACT

A system may include a plurality of consolidation stations and a carousel moving the plurality of consolidation stations past a picking location, one or more consolidation stations of the plurality of consolidation stations receiving one or more items at the picking location. The system may include a first transportation mechanism adapted to bring one or more cartons to the picking location at the carousel. The system may include a robotic arm articulating to move the one or more items from one or more mobile storage units into the one or more consolidation stations at the picking location. The system may include a transfer mechanism adapted to transfer items from the one or more consolidation stations into the one or more cartons.

### BACKGROUND

This application relates to warehouse fulfillment systems. For example, this application relates to an automated, efficient picking station that picks items into shipping cartons.

Existing systems for fulfilling orders pick items into cartons one-by-one, often using human pickers that seek out items in a warehouse and then place them into shipping cartons. Human based systems result in errors, fatigue, and increased task time.

Some fulfillment systems use robots to transport shelves holding a plurality of items from a storage area to a picking station where a human places picks items from the shelves. Unfortunately, these more automated systems require just-in-time transportation of the shelves to the picking station, which results in downtime, increased quantities or conflicts for robots, and many other issues. Furthermore, these systems tend to be inflexible, are only useful in limited situations, and only useful for single item picks.

These previous systems required human picking and/or high complexity, and the quantity of robots required were expensive, deployed slowly, and required substantial amounts of maintenance.

### SUMMARY

A picking system can be configured to perform particular operations or actions by virtue of having software, firmware, hardware, or a combination of them installed on the system that in operation causes or cause the system to perform the actions. Similarly, various hardware components are described that improve picking technologies, including over those issues described in the Background.

In some aspects, the techniques described herein relate to a system including: a plurality of consolidation stations and a carousel moving the plurality of consolidation stations past a picking location, one or more consolidation stations of the plurality of consolidation stations receiving one or more items at the picking location; a first transportation mechanism adapted to bring one or more cartons to the picking location at the carousel; a robotic arm articulating to move the one or more items from one or more mobile storage units into the one or more consolidation stations at the picking location; and a transfer mechanism adapted to transfer items from the one or more consolidation stations into the one or more cartons.

In some aspects, the techniques described herein relate to a system, further including: a motor coupled with the carousel that causes the carousel to rotate and position the one or more consolidation stations at one or more of the picking location and a transfer location.

In some aspects, the techniques described herein relate to a system, wherein: each of the one or more consolidation stations include a bottom surface and three walls, the transfer mechanism interacting the consolidation station to move the one or more items into the one or more cartons.

In some aspects, the techniques described herein relate to a system, wherein: the transfer mechanism is located at a stationary point along the carousel, the transfer mechanism causing the one or more items in the one or more consolidation stations to fall through a chute and into the one or more cartons held by the first transportation mechanism.

In some aspects, the techniques described herein relate to a system, wherein: each of the one or more consolidation stations include a tray that is adapted to pivot upwards to place a bottom surface of the tray at an angle to horizontal and cause the one or more items to slide off the bottom surface; and the transfer mechanism is adapted to lift an edge of the tray upwards to place the bottom surface at the angle.

In some aspects, the techniques described herein relate to a system, wherein: the transfer mechanism includes a pushing mechanism that translates horizontally to push the one or more items horizontally off of the one or more consolidation stations.

In some aspects, the techniques described herein relate to a system, wherein: the transfer mechanism includes one or more doors at a bottom of the one or more consolidation stations, the transfer mechanism opening the one or more doors to cause the one or more items to fall into the one or more cartons.

In some aspects, the techniques described herein relate to a system, wherein: the first transportation mechanism includes a conveyor passing under the carousel, the one or more cartons remaining on the conveyor when the one or more items are transferred into the one or more cartons.

In some aspects, the techniques described herein relate to a system, further including: a second transportation mechanism adapted to bring the one or more mobile storage units to a receiving area accessible to the robotic arm, the one or more mobile storage units holding the one or more items when the one or more mobile storage units are transported on the second transportation mechanism.

In some aspects, the techniques described herein relate to a system, wherein: the second transportation mechanism includes a conveyor, the conveyor carrying the one or more mobile storage units to the picking location and within reach of the robotic arm.

In some aspects, the techniques described herein relate to a method including: transporting one or more storage units holding one or more items to a carousel, the carousel including one or more consolidation stations; transferring one or more first items of the one or more items from a first storage unit of the one or more storage units into a first consolidation station of the one or more consolidation stations at the carousel; rotating the carousel by a first distance to position the first consolidation station at a transfer location; and transferring the one or more first items from the first consolidation station into a carton.

In some aspects, the techniques described herein relate to a method, wherein: rotating the carousel includes moving a plurality of consolidation stations around a loop.

In some aspects, the techniques described herein relate to a method, wherein: transporting the one or more storage units to the carousel includes causing a conveyor holding the one or more storage units to move until the one or more storage units are within reach of a robotic arm; and transferring the one or more first items to the first consolidation station includes articulating the robotic arm to move the one or more first items from the one or more storage units to the first consolidation station.

In some aspects, the techniques described herein relate to a method, further including: consolidating the one or more first items and one or more second items into the first consolidation station prior to transferring the one or more first items from the first consolidation station into the carton, the one or more second items being transferred with the one or more first items into the carton.

In some aspects, the techniques described herein relate to a method, further including: transferring the one or more first items into a plurality of consolidation stations including transferring a first set of the one or more first items into the first consolidation station, rotating the carousel, and transferring a second set of the one or more first items into a second consolidation station.

In some aspects, the techniques described herein relate to a method, further including: transporting the carton to the transfer location at the carousel using a conveyor; and transporting the carton away from the carousel using the conveyor after the one or more first items have been transferred from the first consolidation station into the carton.

In some aspects, the techniques described herein relate to a method, further including: assigning a first order and second order to be automatically picked at the carousel, the first order and the second order including the one or more first items; assigning the first consolidation station to the first order, the first consolidation station receiving items in the first order including a first set of the one or more first items; and assigning a second consolidation station to the second order, the second consolidation station receiving items in the second order including a second set of the one or more first items, the carousel including the first consolidation station and the second consolidation station.

In some aspects, the techniques described herein relate to a method, wherein: transferring the one or more first items from the first consolidation station into the carton is responsive to determining that all items in an order assigned to the first consolidation station have been consolidated into the first consolidation station.

In some aspects, the techniques described herein relate to a method, wherein: rotating the carousel includes rotating a motor coupled with the carousel until the first consolidation station is at one or more of the transfer location and a picking location; and transferring the one or more first items from the first consolidation station includes electronically actuating a transfer mechanism that causes the one or more first items to be moved from the first consolidation station into the carton.

In some aspects, the techniques described herein relate to a system including: a plurality of consolidation stations around a carousel that moves one or more of the plurality of consolidation stations to a picking location, the one or more consolidation stations receiving one or more items at the picking location; a first transportation mechanism adapted to bring one or more cartons to the picking location at the carousel; a robotic arm adapted to move the one or more items from one or more mobile storage units into the one or more consolidation stations at the picking location; a transfer mechanism at a transfer location (e.g., at a stationary, fixed, or varying position, depending on the implementation) and adapted to transfer the one or more items from the one or more consolidation stations into the one or more cartons; and one or more processors that perform operations including: instructing the robotic arm to transfer the one or more items from the one or more mobile storage units into the one or more consolidation stations at the picking location; instructing a motor coupled with the carousel to rotate the carousel by a first distance to position the one or more consolidation stations at the transfer location; and instructing the transfer mechanism to transfer the one or more items from the one or more consolidation stations into the one or more cartons.

Other implementations of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 depicts an example system and data communication flow for implementing an automated robotic replenishment system, which may use the carousel system described in further detail herein.

FIG. 2 illustrates an example layout of a portion of a fulfillment center used in an automated robotic fulfillment system.

FIG. 3 is a flowchart of an example method for automated robotic multi-line picking and buffering using a carousel station.

FIGS. 4A-4I illustrate various views of an example implementation of a carousel picking station.

FIGS. 5A-5J illustrate various views of an example implementation of a carousel picking station.

FIGS. 6A-6H illustrate various views of an example implementation of a carousel picking station.

FIGS. 7A-7C illustrate various views of an example implementation of a carousel picking station.

FIG. 8 is a block diagram illustrating an example computing system.

### DESCRIPTION

The technology described herein may be used in an automatic, robotic replenishment, organizing, or fulfillment system in a warehouse. For instance, the technology described herein may be applied in various contexts to move items from first containers into second containers, such as from storage units into shipping cartons. It should be noted that the configurations may take various forms and have various materials without departing from the scope of this disclosure.

The described technology and system may act as a dynamic buffer where a picker (e.g., a robotic arm, human, or other device) can pick a SKU (e.g., an item having a certain stock keeping unit identifier) used for one or multiple orders rather than waiting for a box to arrive to complete the pick. For example, this technology improves the picking process, among other reasons, as multiple items from the system can be picked at one time and the effort (e.g., by automatic guided vehicles) required to move the tote to a corresponding pick cell is reduced. The technology also improves fulfillment of multiline (e.g., having multiple items of one or multiple SKUs) orders as it allows items in the order to be stored until the items are picked, at which time they may be moved (e.g., pushed) at once into a box, such as a shipping carton.

The technology described herein improves multi-line picking in a robotic environment, for example, in a completely or partially automated picking system for multiline picking. The technology reduces costs, may be deployed faster in new fulfillment centers, and requires little maintenance. Additionally, its design is robust and results in fewer errors and alerts than previous systems.

The technology may include a system and method for picking items into boxes, such as shipping cartons, for example, using a carousel. A carousel may include multiple trays or item consolidation holders/areas that may be moved relative to a picking location at a picking station. For example, a series of un-assigned (e.g., un-assigned to a specific order) cartons may be conveyed to a robotic-arm station where a robotic arm transfers items into one of several consolidation areas/stations around the carousel. Once an order on the carousel is complete, the consolidation area(s) holding its item(s) may be rotated to be above or adjacent to a shipping carton into which the order is dropped. The shipping carton is then conveyed away on a conveyor where it receives a corresponding label and packing materials.

In some implementations, the technology may include a box erector or former that places cartons onto a first conveyor, which conveys the boxes past a pick receiving area corresponding to a carousel. The first conveyor conveys items past a print and pack station, box closer, or other components.

In some implementations, a carousel may have several radially located consolidation stations into which items may be placed by a diverter, robotic arm, or other device. In some implementations, one or each consolidation station includes a door via which the consolidated items are dropped into a cart at the pick receiving area. In some implementations, a consolidation station/tray/area may be dumped or items may be pushed therefrom by a transfer mechanism. A consolidation station may include a tray and other components (hinges, bolts, etc.) or may, for purposes of description herein, be used interchangeably with the term tray. The system may also include a second conveyor, which conveys totes, mini pallets, or other mobile storage units past a robotic arm or other picker, which removes items from the totes and places them into consolidation station(s). In some implementations, an AGV (automated guided vehicle or other robotic transportation device, such as an automated forklift, etc.) may transport the totes to/from the second conveyor.

Various operations, features, and components for implementing the technology are described throughout this disclosure, such as in reference to the examples illustrated in the figures.

The technology described herein relates to an automated system comprising various software and hardware devices, for example, an automated robotic picking system, which may incorporate carousel-based consolidation trays, areas, or stations. The technology may include beneficial configurations, operations, features, and interactions. Among other benefits, the technology described herein improves upon that described in the Background Section. For instance, the technology provides robotic devices, systems, methods, and other aspects that can more efficiently perform picks.

In some implementations, the technology may provide integration, coordination, and control of various systems to intelligently move items and reduce human interaction, which increases speed and accuracy.

In some instances, the technology may include various computing devices or controllers coupled with equipment, such as the robotic arm(s), optical sensors or cameras, AGV(s), carousel motors, consolidation area transfer mechanisms, conveyors, other equipment, sensors (e.g., optical sensors, scanners, etc.) human interface system(s), and other devices. In some implementations, the components may communicate with each other directly, for instance, via a network or communication bus. In some implementations, a central control system, such as a warehouse management system (WMS) or other system may receive signals, perform computations, and issue commands to other devices.

Features of the technology described herein can be integrated into any logistics system, dispatch system, warehouse execution system, warehouse management system, a robot execution server, etc., to coordinate the operations of various systems, information, and devices in a fulfillment system. The technology described herein may provide a fully or partially automated system that provides redundancy, reduces the number of operations, and provides many other benefits described herein. The technology beneficially improves productivity and throughput, increases asset utilization, and lowers cycle time and labor costs. These benefits, in turn, lead to shorter delivery times and result in significant time and resource savings along with reduced error rates.

With reference to the figures, reference numbers may be used to refer to example components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

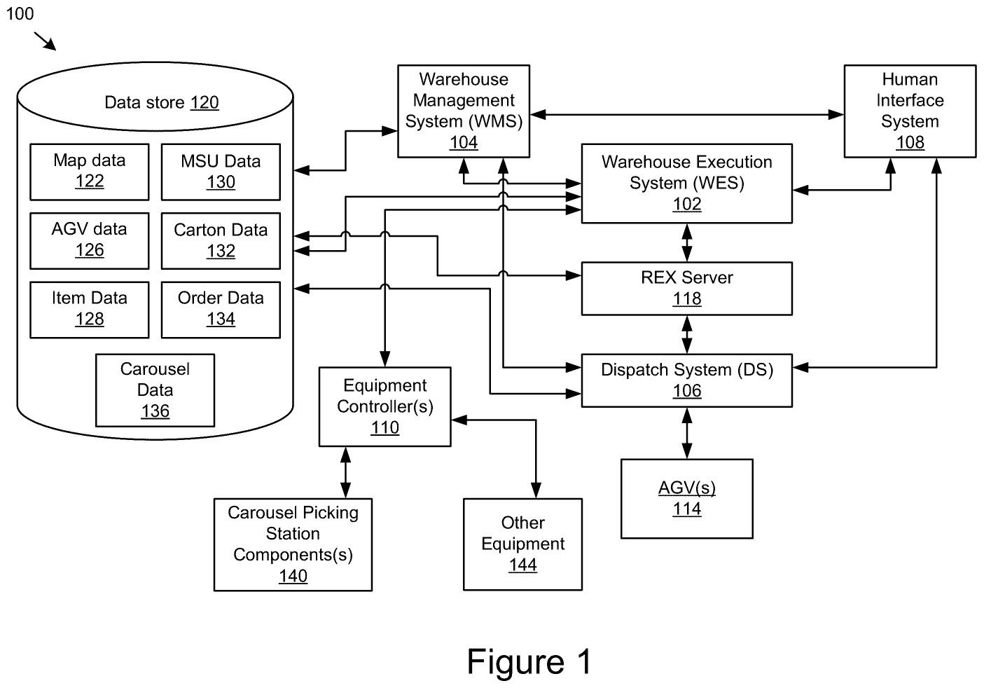

FIG. 1 depicts an example system 100 and data communication flow for implementing an automated robotic replenishment system, which may use the carousel system described in further detail herein. The system 100 includes a warehouse execution system (WES) 102. The WES 102 is coupled to equipment controller(s) 110, a warehouse management system (WMS) 104, a data store 120 storing various data, a human interface system 108 (e.g., pick-to-voice, pick-to-light, graphical user interface(s), etc.), a robot execution server (REX) 118, a dispatch system 106, and other systems. For instance, the system 100 may include carousel picking station component(s) 140 (also referred to herein as a carousel picking station 202 or carousel station 202) or other systems, and/or other equipment 144, such as optical sensors or cameras, conveyors, printers, conveyors, robots, or other devices.

The WES 102 may, in some implementations, include one or more hardware and/or virtual servers programmed to perform operations, acts, and/or functionality described herein. For instance, the components of the WES 102 may comprise software routines storable in one or more non-transitory memory devices and executable by one or more computer processors of the WES 102 to carry out operations, acts, and/or functionality described herein. In further implementations, these routines, or a portion thereof, may be embodied in electrical hardware that is operable to carry out the operations, acts, and/or functionality described herein.

For example, the WES 102 may be communicatively coupled with scanner(s), carton conveyor(s) 242, item conveyor(s), diverter(s), carousel picking station component(s) 140, camera(s), robotic arms 210, and other equipment 144 either directly or via the equipment controller(s) 110, which may be programmable logic controllers (e.g., conveyor controllers, conveyor scanner controllers, automated induction equipment controllers, other warehouse equipment controllers, or other computing devices for controlling equipment).

In some implementations, the WES 102 may receive, process, and transmit data to control software and hardware interactions, for example, by consolidating and controlling information across systems, as described herein. For instance, the WES 102 may serve as a decision point or control software that processes data streams for receiving data, processing the data, instructing devices, and other computations, as noted herein. For example, the WES 102 may communicate with equipment controller(s) 110 and/or other systems to perform operations respective to the carousel station 202. One or more of these operations may be performed via communication with various equipment of the system 100, as described in further detail herein. Accordingly, the WES 102 may provide unified communication that coordinates various systems.

The WES 102 and/or WMS 104 (together or separately) may communicate with various other systems and devices to perform its operations, as described herein, such as equipment controller(s) 110 and equipment. The WES 102 or WMS 104 may communicate with equipment or a human-interface system 108, which may provide instructions for picking items or correcting errors, for instance.

The other equipment 144 may include an item handling station (e.g., where items are placed on a conveyor belt), other box erectors, label applicators, scanners, picking equipment, or other devices for inducting or moving items, mobile storage units (also referred to herein as mobile storage units or totes 218), cartons 222, or other objects in the system; scanners that may include optical, radio, or other scanners or sensors that scan items, containers, totes or other mobile storage units 218, or cartons 222 to identify them; conveyors that may include one or more conveyor belts or other devices that convey objects (e.g., items, mobile storage units or totes 218, cartons 222, or other objects), for instance, as described herein Other equipment 144 may include various other downstream devices, such as label applicators, carton-closing equipment, control systems, printers, actuators, motors; or various other devices.

The REX server 118 may, in some implementations, include one or more hardware and/or virtual servers programmed to perform operations, acts, and/or functionality described herein. The REX server 118 may generate a schedule that defines the route for an AGV 114. For a given AGV 114, the REX server 118 may generate an AGV 114 schedule and transmit it to the dispatch system 106, which in turn deploys an AGV 114 according to the schedule or instruction, for instance. In some implementations, the dispatch system 106 instructs the AGV 114 to proceed through one or more areas of the distribution facility according to the schedule/instruction. The schedule of each of the AGVs 114 may be coordinated such that an optimal flow can be achieved. For example, as described elsewhere herein, the REX server 118 may instruct an AGV 114 to retrieve a defined mobile storage unit or tote 218 from a storage area and transport it to a carousel station 202, such as at a receiving location or conveyor associated therewith.

In some implementations, the REX server 118 may include or may communicate with a routing engine, which may route AGVs 114 and/or objects (e.g., items, mobile storage units, etc.) in a fulfillment center.

The dispatch system 106 may be electronically communicatively coupled to a plurality of automated guided vehicles (AGVs) 114. In some implementations, the dispatch system 106, or elements thereof, may be integrated with or communicatively coupled with the REX server 118. The dispatch system 106 includes hardware and software configured to dispatch the AGVs 114 and is coupled for communication the components of the system 100 to receive instructions and provide data. The dispatch system 106 may calculate a route to execute the task considering traffic and resources. In some cases, it adjusts the route or the task in order to make the route efficient.

The AGVs 114 may be robotic vehicles including drive units providing motive force for moving the AGVs 114 (and, in some instances, items, storage units, etc.), guidance systems for determining position of the AGVs 114 within the distribution facility, and equipment for carrying items. Some AGVs 114 may be attached to, include, or carry carts, which, in turn, carry items or storage units. Various configurations of AGVs 114 may be used, such as those with forklifts, robotic arms 210, or other configurations. In some implementations, in addition to or in lieu of AGVs 114, conveyors or other conveyance mechanisms may be used to transport mobile storage units 218 (e.g., pallets, totes, etc.) or other objects.

The WMS 104 may, in some implementations, include one or more hardware and/or virtual servers or software routines storable in one or more non-transitory memory devices and executable by one or more processors to perform operations, acts, and/or functionality described herein. The WMS 104 may be configured to store and maintain data in the data store 120. In some implementations, the WMS 104 may be configured to communicate with the WES 102, the human interface system 108, dispatch system 106, and/or other systems in real time, in batches, as requested by these components, etc. For example, the WMS 104 may receive data from an e-commerce or other server, process the data, and update various data in the data store 120 based on the order data. Similarly, the WMS 104 may detect and update inventory and other data.

It should be noted that operations described herein in reference to the WMS 104 may be performed by other devices or by other components of the system 100. Similarly, it should be noted that the operations described in reference the WMS 104 and the other components of the system 100 may be distributed or shifted among the components of the system without departing from the scope of this disclosure. For instance, some operations described in reference to the WES 102 or WMS 104 may be performed by the equipment controller(s) 110 or REX server 118, or some operations described in reference to the equipment controller(s) 110, REX server 118, or carousel picking station component(s) 140 may be performed by the WMS 104 or WES 102.

The human interface system 108 may, in some implementations, include one or more hardware and/or virtual servers or software routines storable in one or more non-transitory memory devices and executable by one or more processors to perform operations, acts, and/or functionality described herein. The human interface system 108 may provide instructions and/or receive data (e.g., scan data, user input, confirmations), for example, from human agents or operators (e.g., using barcode scanners, NFC, RFID or radio-frequency identification chips, or other sensors or input methods), as described in further detail below. An example human interface system 108 may include audio, illumination, or a graphical user interface system that receives inputs and/or provides instructions to human agents. The human interface system 108 may be configured to communicate the data with the WES 102, WMS 104, or other components of the system in real time, in batches, as requested by the components of the system, etc.

The human interface system 108 may receive scan data from a client device based on a user scanning a barcode or other identifier of an item, conveyance device, tote, etc. The human interface system 108 may provide instructions to users indicating to place certain items, containers, totes or mobile storage units 218, etc., at certain locations, remedy errors or exceptions, or perform other actions. For instance, the human interface system 108 may instruct a user to place an item on a consolidation tray, clear a clog in a chute or transfer area of a carousel station 202, or perform other actions.

In some implementations, for example, an equipment controller 110 may detect that an error has occurred at a carousel station 202, such as where an item is stuck in a transfer area or funnel/guide. The equipment controller 110 may communicate with the human interface system 108 directly or via a WES 102 or other component to issue instructions to a human agent to clear the error.

The data store 120 is an information source for storing and providing access to data. The data stored by the data store 120 may be organized and queried using various criteria including any type of data stored by it. The data store 120 may include data tables, databases, or other organized collections of data. An example of the types of data stored by the data store 120 may include, but is not limited to map data 122, pallet data, AGV data 126, item data 128, MSU (mobile storage unit) data, carton data 132, order data 134, carousel data 136, or other data. In some instances, the data store 120 may also include system attributes, sensor data, labels, system health, etc.

The data store 120 may be included in the WES 102, WMS 104, equipment controller(s) 110, REX server 118, or in another computing system and/or storage system distinct from but coupled to or accessible by the WES 102, WMS 104, REX server 118, equipment controller(s) 110, or other components of the system 100. The WES 102, WMS 104, human interface system 108, REX server 118, and/or dispatch system 106, for example, may store and maintain data in the data store 120. The data store 120 can include one or more non-transitory computer-readable mediums for storing the data. In some implementations, the data store 120 may store data associated with a database management system (DBMS) operable on a computing system. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The map data 122 may include data reflecting the 2- or 3-dimensional layout of the facility including example locations of storage units, automated carousel station component(s) 140 or stations 202, carton receiving areas/spaces, mobile storage unit receiving area/spaces, conveyors, equipment, storage shelving units, items, AGVs 114, conveyors, etc. Map data 122 may indicate the attributes of the distribution facility, including attributes of zones/areas of a warehouse. For example, attributes of zones may include the number, quantity, and location of shelving units or bays, storage units, items, boxes/cartons 222, guidance system locators or markers, etc.

The AGV data 126 may describe the state of an AGV 114, such as operational state, health, location, battery life, storage capacity, objects (e.g., items, mobile storage units, totes 218, pallets, etc.) being carried, cartons 222, whether a picker is assigned to it, etc.

The item data 128 may describe items in a distribution facility. The item data 128 may include unique identifiers for these items, the item volume (e.g., the total amount picked in given window (e.g., in an hour, day, etc.)), the item velocity (e.g., number of different times item picked in given window (e.g., per hour, day etc.), the location of the items within the distribution facility (aisle, shelf, shelf position, mobile storage unit or tote 218, mobile storage unit partition, conveyance device, pallet, etc.), other attributes of the item (e.g., size, description, weight, quantity of items in a package, color, quantity of packages in a container, etc.), item inventory, or mapping of items to storage units, orders, conveyor locations, carousel station components(s) 140 or stations 202, trays in a carousel station, pallets, totes, etc. In some implementations, the item data 128 may include the quantity of particular items a storage unit/tote contains, the current location of a storage unit, a storage location of items and/or storage units, and other data. For instance, the item data 128 may include visual aspects, labels, QR codes, identifying markers, etc., that may be used by the WES 102, WMS 104, or equipment controller(s) 110, etc., to identify items, for example, based on a scan of an item.

The MSU data 130 may include information about mobile storage units, containers, or totes 218 in the system, such as a unique identifier or license plate number for each mobile storage unit or container, a mobile storage unit or container type, the zones a mobile storage unit will visit, the current or assigned location of a mobile storage unit, and the priority for the mobile storage unit. The MSU data 130 may include a list indicating the items, item types, and/or the quantity of items a mobile storage unit/tote 218 (or a partition thereof) contains or should contain (e.g., it's maximum or assigned capacity).

The carton data 132 may include various attributes describing box formers (e.g., 232 as noted below), available box sizes, box sizes associated with a box former, box size(s) associated with an order, the state of each box former, box former queues, or other data described herein. For example, the carton data 132 may include license plate numbers or other identifiers on cartons 222, status and locations of cartons 222 in the systems (e.g., on conveyors), orders or items assigned to cartons 222, and other data.

Order data 134 may include data pertaining to orders to-be-fulfilled, being fulfilled, and/or already fulfilled in the fulfillment center. For example, the order data 134 may include tables or other files indicating which items are associated with orders, attributes of the items, attributes of the orders, shipping information, box size needed for the items, carousel stations 202 to which orders are assigned, status information, or other information for orders.

Carousel data 136 may include various data describing a carousel, such as its location, status, orders assigned to the station, mobile storage unit/tote 218 assigned to or at the station, cartons 222 assigned to or at the station 202, or other data. For example, as described below, orders and associated items may be assigned to be picked at a carousel. Orders and/or items may be assigned to and then tagged as pick are completed into defined consolidation trays of the carousel station 202, which may track completion of orders, picking of items, position of trays/the carousel, operations of a human, diverter, or robotic arm (e.g., 210), or other information, such as that described herein.

The components of the system 100 may be coupled to exchange data via wireless and/or wired data connections. The connections may be made via direct data connections and/or a computer network. The computer network may comprise any number of networks and/or types of networks, such as wide area networks, local area networks, virtual private networks, cellular networks, close or micro proximity networks (e.g., Bluetooth, NFC, etc.), etc. In some implementations, one or more of these components may be coupled via a data communications bus.

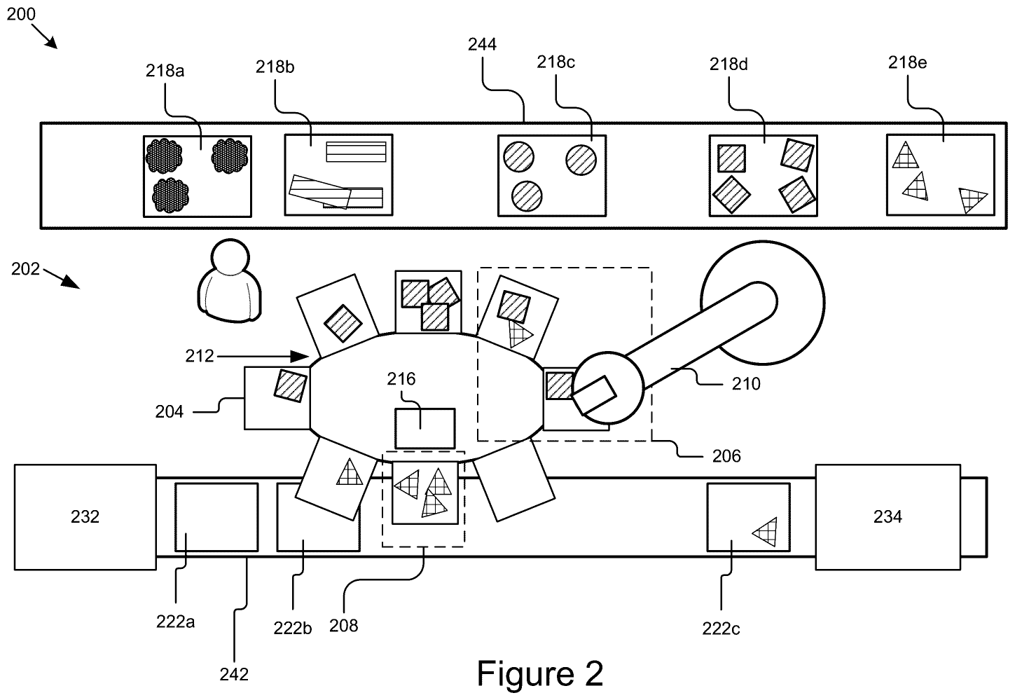

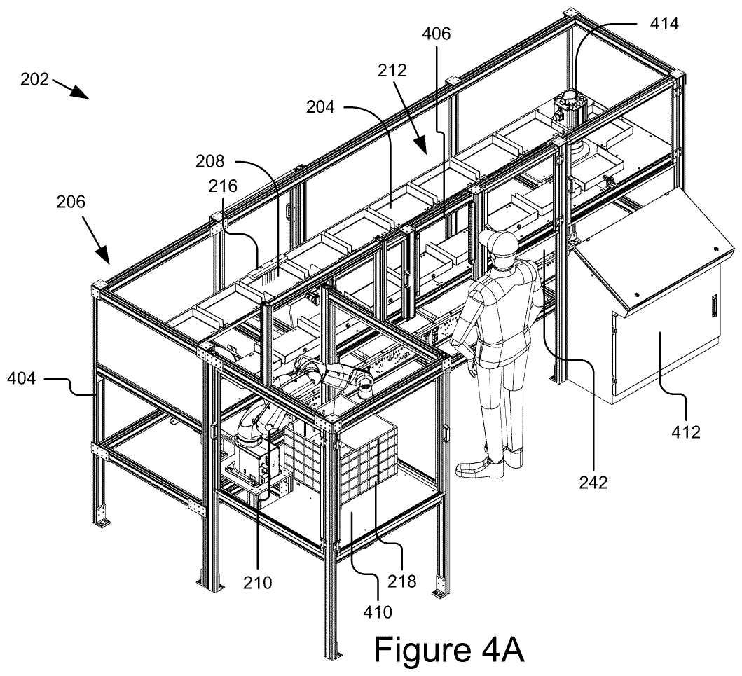

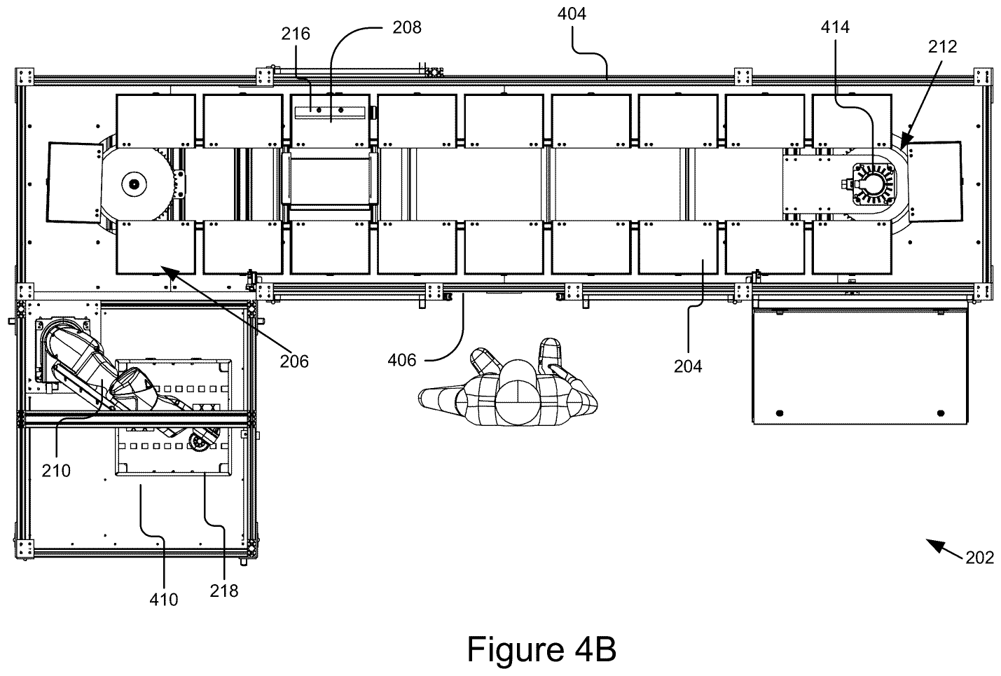

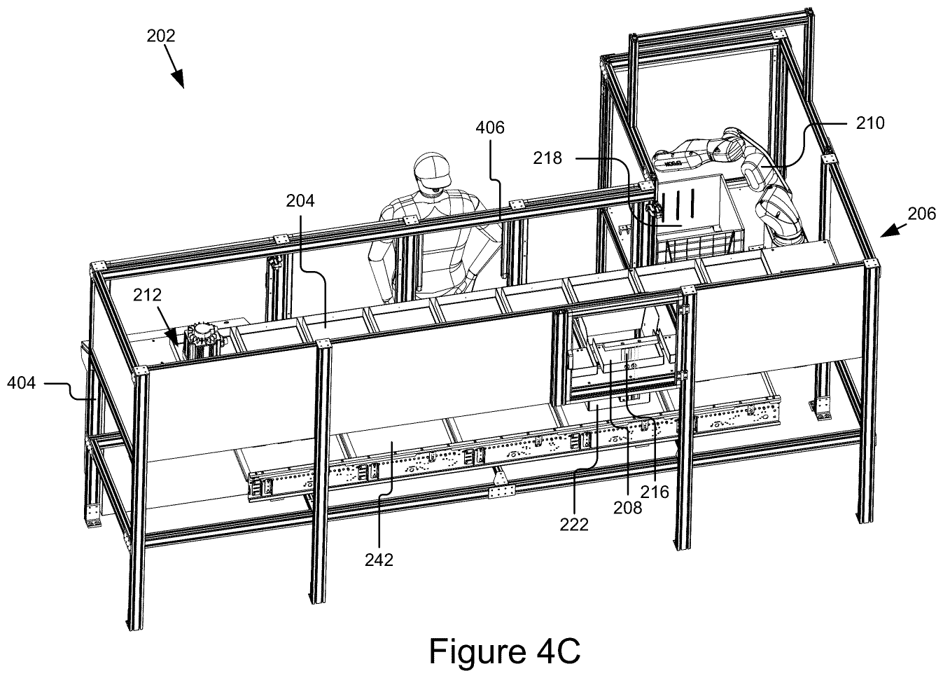

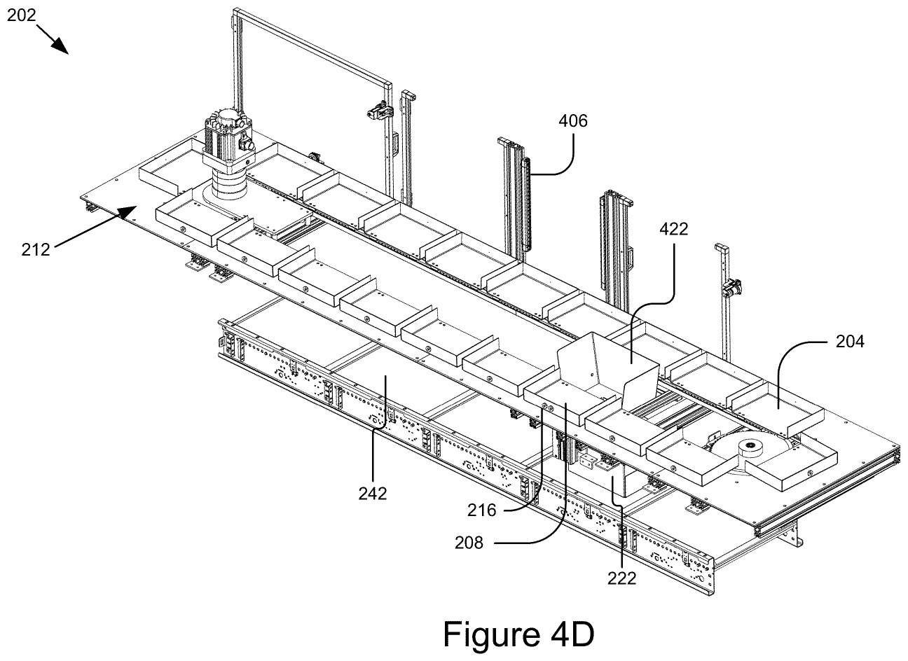

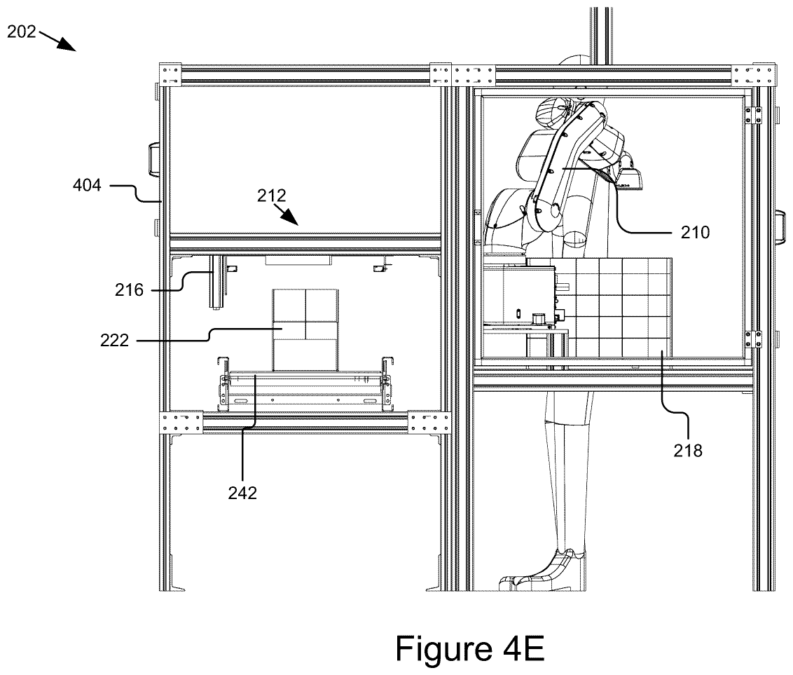

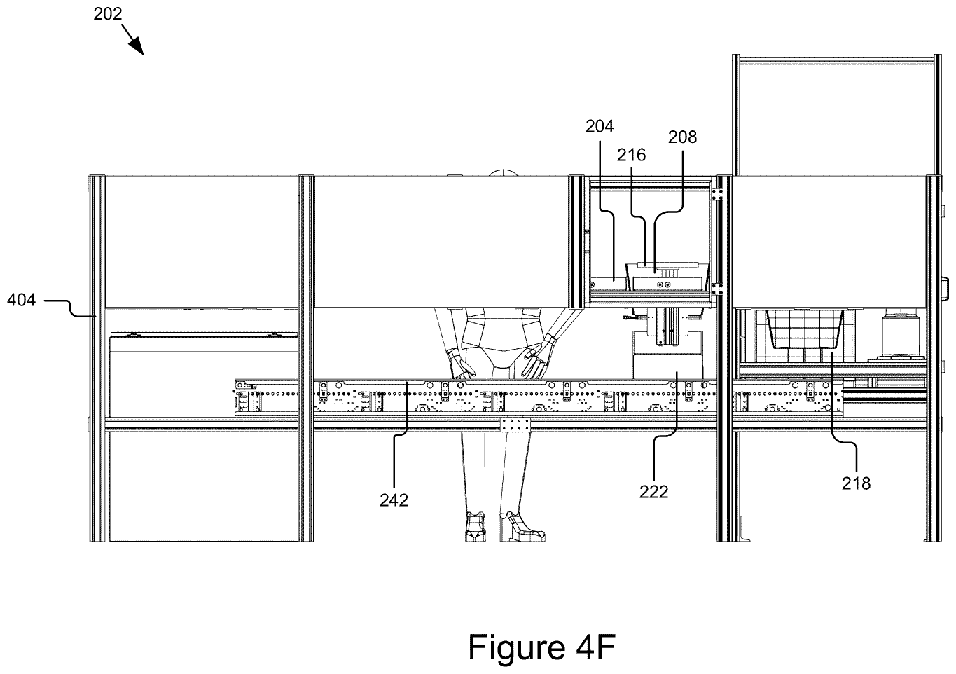

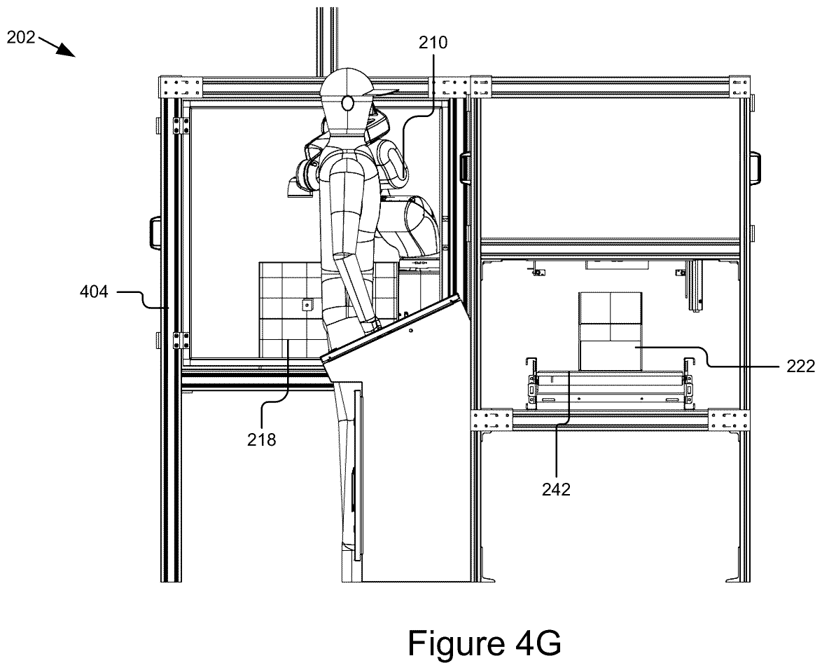

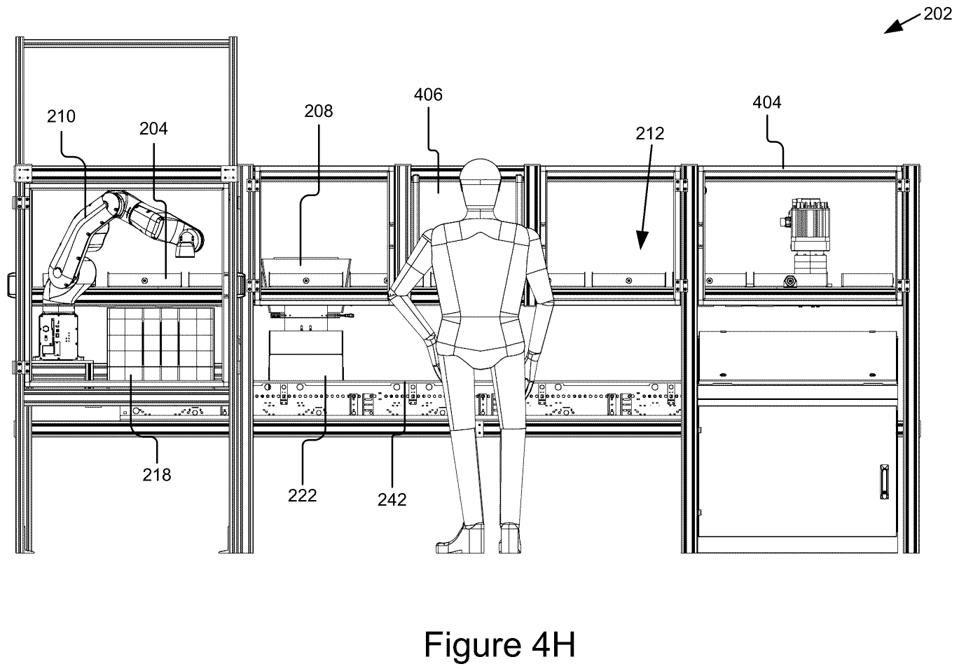

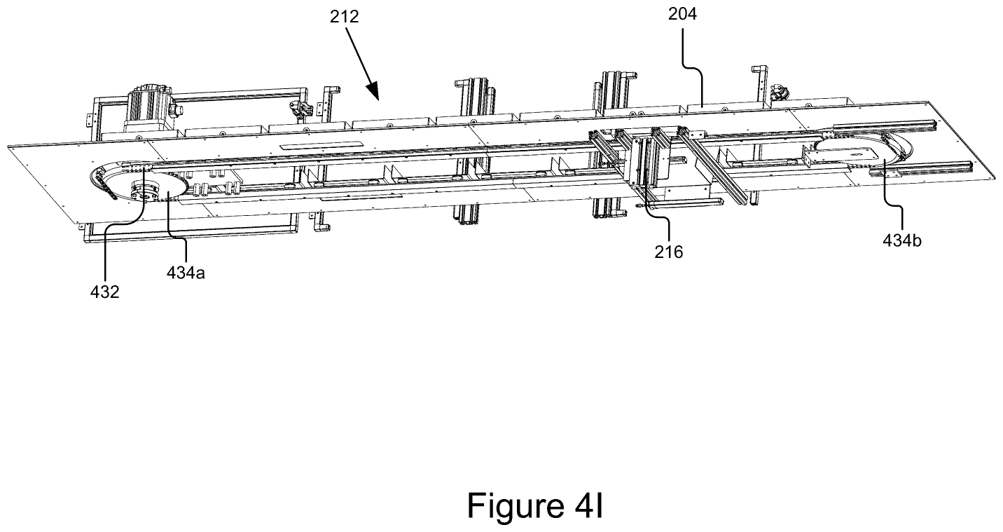

FIG. 2 illustrates an example layout 200 of a portion of a fulfillment center used in the automated robotic fulfillment system. For instance, the layout 200 illustrates a top-down view of an example carousel station 202, which may include or be adjacent to conveyors or receiving areas for mobile storage units and/or cartons 222. It should be noted that the layout 200 is provided as an illustrative example of the technology described herein and that other layouts, configurations, and uses may be used. Additionally, FIGS. 4A-7 illustrate example layouts using carousel stations 202 according to implementations of the technology described herein. While certain examples are described, the operations, components, and features described herein may be modified, interchanged, omitted, or augmented without departing from the scope of this disclosure. It should be noted that while certain movements, interactions, paths, locations, and devices are illustrated, other implementations are possible and contemplated herein.

It should be understood that various facilities may include different configurations. For instance, a fulfillment center, distribution facility, or other location may use some or all of the aspects of the example layout. It should be noted that other configurations, components, or layouts are possible and contemplated herein, and the examples are provided by way of illustration.

The example layout 200 illustrates a carousel station 202 with a carousel 212 that includes a plurality of consolidation stations 204, which may also be referred to as areas or trays herein, although various shapes and configurations are possible and contemplated. For example, consolidation stations 204 may be located along a belt, chain, track, or other structure that allows the consolidation stations 204 to move or otherwise be accessible to one or more of a picking location 206, transfer location 208, robotic arm 210, or other component. In some implementations, the carousel 212 may be a loop, such as a circle, oval, rectangle, or other shape that allows continuous movement of the consolidation stations 204 in the loop. In some implementations, the carousel 212 may include a linear or other arrangement.

The carousel 212 (e.g., a chain thereof) may be coupled with a computer-controlled motor (e.g., 414) and/or one or more sensors that allows the equipment controller(s) 110 to position consolidation stations 204 at various locations.

The carousel station 202 may include one or more picking locations 206 at which consolidation stations 204 may be positioned. For example, a picking location 206 may be a location at which items are placed into/onto one or more consolidation stations 204. A picking location 206 may be adjacent to/within reach of a robotic arm 210 or other device, so that the robotic arm 210 may place items in the consolidation station 204 at the picking location(s) 206. In some implementations, one or more consolidation stations 204 may be accessible to one or multiple devices may be used to place items into a consolidation station 204, such as a human picker, a robotic arm 210, a diverter, or other mechanism. In some implementations, the picking location(s) 206 may include one or more cameras or sensors that scan items held by an arm or otherwise transferred to confirm its identity or quantity.

The carousel station 202 may include one or more transfer locations 208 at which items are transferred from one or more consolidation stations 204 into a carton 222 (e.g., cartons 222a, 222b, and 222c are illustrated in FIG. 2), such as a shipping carton 222. The transfer location(s) 208 may be located along a conveyor that carries shipping cartons 222, so that a shipping carton 222 may be placed at a transfer location 208 at which items are transferred from a consolidation station 204 into the carton 222. For example, as illustrated, a transfer mechanism 216 at the transfer location 208 may allow items to be pushed off, slid off, dropped through, or otherwise moved from a consolidation station 204 and into a carton 222, which may be on a conveyor 242.

The transfer location(s) 208 may include various mechanisms (also referred to as transfer mechanisms 216 herein) for transferring items from a consolidation station 204 into a carton 222, such as a pusher that pushes items sideways off the consolidation station 204 and into a carton 222 (e.g., toward a center or outer edge of the carousel 212, as illustrated), which items may be guided by one or more guides, funnels, or chutes at the transfer location 208. Although only one transfer location 208 is illustrated, multiple may be used. For example, a consolidation station 204 may be open at one side and a transfer mechanism 216 may push items from the consolidation station 204 into a carton through the open side.

Another example transfer mechanism 216 may include that the consolidation station 204 is hinged at one side, so that an edge may be lifted up to create a slope that causes items to slide into a carton 222 (e.g., through an aperture using a guide). For instance, a pusher (e.g., a pneumatic or hydraulic ram or linear actuator) may be located below the transfer location 208 and may push upwards on a tray/consolidation station 204 in order to cause it to tilt and dump items therefrom.

In another example mechanism, a consolidation station 204 may be open at a bottom or include a door at a bottom that allows items to pass through the opening when the bottom or door is opened, such as when it is rotated to a defined position or actuated.

In some implementations, other equipment or devices 234 (e.g., printers, label applicators, box closers, etc.) may be placed at or adjacent to a transfer location 208 so that when a carton 222 is assigned to an order and receives items, labels can be applied to the carton 222, packing slips may be placed into the carton 222, and otherwise, although the other equipment may be located at other positions, such as downstream on the conveyor.

The carousel station 202 may include one or more devices for moving items into a consolidation station 204. For example, diverters, cranes, robotic arms 210, or other devices may be used. As illustrated in examples herein, a robotic arm 210 may be positioned, so that it may access both consolidation stations 204 and mobile storage units or totes 218. Accordingly, a robotic arm 210 may grasp an item from a mobile storage unit and move it to an assigned consolidation station 204 on the carousel 212.

In some implementations, a human picker may access all or a portion of the carousel station 202 in order to address errors, pick items (e.g., from a tote 218 into a carton 222), perform maintenance, or perform other operations. The carousel station 202 may include various walls, partitions, or sensors that cause it to cease operations when a human is too close or enters a defined safety zone.

One or more mechanisms for bringing mobile storage units or totes 218 (e.g., totes 218a, 218b, 218c, 218d, and 218e are shown in the example of FIG. 2) to the carousel station 202 may be used. For example, a first or tote conveyor 244 may be used to move storage units to or past a carousel station 202, which may position the storage units at one or more storage unit receiving locations from which the robotic arm 210 may retrieve items. Although a conveyor is illustrated, in some implementations, other mechanisms or structures may be used, such as where one or more AGVs 114 bring one or more storage units 218 to the receiving areas.

Depending on the implementation, humans, AGVs 114, diverters, other conveyors, or other devices may be used to place the mobile storage units or totes 218 on a conveyor 244 or other receiving location from which items may be picked. For example, a REX 118 may instruct an AGV 114 to place an item at a defined location on a conveyor 244, such as at a conveyor induction location. The system may include one or more scanners that identify and/or confirm identification or locations of mobile storage units/totes 218 on the conveyor 244.

Similarly, a second conveyor 242 (also referred to as a carton conveyor 242) may be used to transport items to and/or past the carousel station 202. In other implementations, other mechanisms may bring one or more cartons 222 to the carousel station 202, such as to the transfer location(s) 208, such as AGVs 114, humans, diverters, other conveyors, etc.

One or more box formers/erectors 232 may be placed at a beginning (or upstream) of the carton conveyor 242 to automatically construct and/or place cartons 222 onto the conveyor 242. In some implementations, cartons 222 may be inducted onto the conveyor 242 as orders are completed. For example, when the WES 102 determines that all assigned items are in a consolidation station 204, it may issue an instruction to a box former 232 to construct a carton 222 of defined size (e.g., where multiple sizes or box formers 232 are used), which may then be transported to the transfer location 208 by the carton conveyor 242 as the carousel 212 rotates the completed consolidation station 204 to the transfer location 208.

As illustrated in the example layouts herein, a plurality of mobile storage units 218 are transported to the carousel station 202 using a tote conveyor 244. A first mobile storage unit 218 holding a first SKU may be accessed by a robotic arm 210 first, which may place assigned quantities of the SKU/item in each of one or more assigned consolidation stations 204 as they rotate past the picking location(s) 206 (whether continuously or based on each completed task/line/pick). Once all of that SKU/the items from that mobile storage unit 218 are picked to consolidation stations 204 assigned to hold the SKU, the tote conveyor 244 may move the next mobile storage unit 218 to be accessed by the robotic arm 210, which repeats the picking process for the next mobile storage unit 218. In some implementations, the previous mobile storage unit 218 may be automatically retrieved from the tote conveyor 244 by an AGV 114 and returned to a storage location or another picking station, or it may be otherwise conveyed away on the conveyor 244.

Responsive to determining that a consolidation station 204/tray has received all items, the carousel 212 may be rotated to position the consolidation station 204 at the transfer location 208. In some implementations, upon confirmation that a carton 222 or the assigned carton 222 (e.g., based on a scan, sensor, or a position of a carton 222 and/or carton conveyor 242) is at the transfer location 208, a transfer mechanism 216 may be actuated to move the item(s) into the carton 222.

As described below, a computer algorithm may be used to assign order(s) and item(s) to a carousel station 202, instructions to move mobile storage unit(s) 218 containing the item(s) may be issued, consolidation stations 204/trays may be assigned to an order or set of items (e.g., where multiple consolidation stations 204 or trays are used for a single order or carton 222), task lists and/or files tracking items in each consolidation stations 204 may be updated to track item locations, pick line completion, etc., and other operations.

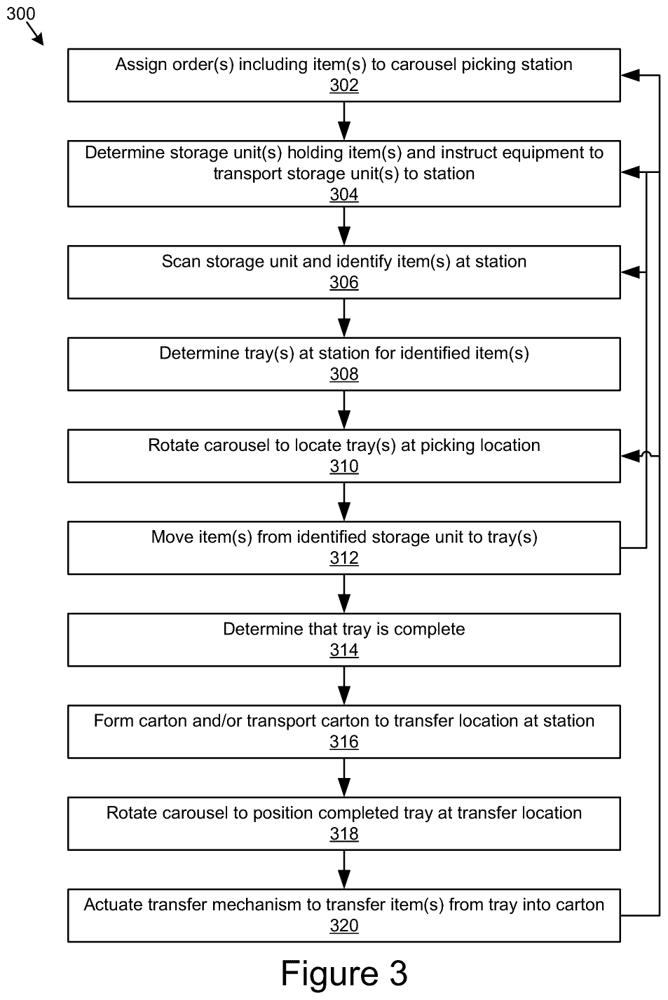

Once items are transferred out of a consolidation station 204, a file or data entry (e.g., in the data store 120) for the consolidation station 204 may be released and reassigned to a next order or set of items. The next order or item may be assigned based on mobile storage unit(s) 218 at the carousel station 202, on the tote conveyor 244, based on similarities with other items/orders on the carousel 212, or based on other conditions. These and other operations are described in further detail below, such as in reference to the example method in FIG. 3.

FIG. 3 is a flowchart of an example method 300 for automated robotic multi-line picking and buffering using a carousel station 202, such as those described elsewhere herein. The operations described in reference to FIG. 3 may be used with components and features described throughout this description. It should be noted that the operations of the method 300 may be used interchangeably or with the other operations and features used herein. Furthermore, it should be noted that operations of the method 300 and of this description may be augmented, reordered, omitted, or modified while still using technologies described in this disclosure.

It should be noted that, although the operations of the method 300 are described as being performed by the WES 102 (e.g., in conjunction with equipment controller(s) 110), other implementations are possible, such as where a dedicated system, machine, computer, server, process, engine, etc., performs the operations. The WES 102 and/or equipment controller 110 may be coupled with various sensors, motors, actuators, and devices, such as those described throughout this disclosure. For instance, they may be controlled by a WES 102, human agent, or other device, such as those of the system 100.

Although described in reference to the WES 102, some operations may be performed directly by the WES 102, by the equipment controller(s) 110, based on communications between these and other components, or otherwise. For example, it should be noted that some or all of the operations may be performed automatically by an equipment controller 110. In some implementations, operations may be controlled by a human user, such as by applying physical force via levers, by pressing buttons, or otherwise.

The operations and features described in reference to FIG. 3, for example, may be described in additional detail throughout this disclosure, both in terms of the operations and mechanical components.

At 302, the WES 102 may assign one or more orders, each including one or more items, to a carousel picking station 202. For example, a number of orders may be assigned to be picked in a fulfillment center at a given time. These orders may each include one or more items that are stored in the fulfillment center.

The WES 102 may filter and sort the orders/items based on attributes thereof and available picking mechanisms. For example, the WES 102 may select those orders having fewer than or greater than a defined number of pick lines/items for picking at carousel stations 202. Similarly, the WES 102 may group the orders based on similarity of items. For example, if multiple orders contain one or more of the same item, they may be assigned to be picked together, for example, at the same time period or in sequence at the same carousel station 202.

For example, if a carousel station 202 has 20 trays and there are 10 orders for the same SKU (e.g., SKU A) to be fulfilled, the WES 102 may assign the 10 orders to be picked as a cluster. Remaining slots may be selected based on a next-most similar order (e.g., orders having SKU A and SKU B). The assignment process may be iterated until a threshold number of orders for a carousel station 202 are selected. In some implementations, a queue may also be assigned so that subsequent picks can be determined beyond those actively at the carousel station 202, and mobile storage units 218 can be proactively transported to a conveyor and/or carousel station 202. Similarly, allowance for clusters or sequences of the same order or similar items may be determined.

In some implementations, mobile storage units 218 may be assigned and then orders assigned based on the mobile storage units 218 or vice versa. As an order or mobile storage unit 218 is completed, the WES 102 may assign a next order or mobile storage unit 218, so that the carousel station 202 may be continuously used.

In some implementations, individual trays/consolidation stations 204 at the carousel 212 may be assigned to an order or portion of an order (e.g., in some instance, multiple trays may be assigned to a single order). Additional or other logic may be used to coordinate with other components and tasks in the fulfillment center. Similarly, other operations for determining orders and items for a carousel station 202 may be used with the technologies described herein.

At 304, the WES 102 may determine one or more storage units 218 holding items/corresponding SKUs and instruct equipment, such as AGVs 114, conveyors 244, and/or other devices, to transport mobile storage units 218 to the carousel station 202. For example, the WES 102 may search MSU data to determine one or more mobile storage units 218 having a sufficient quantity of the items for an order or set of orders. The WES 102 may communicate with a REX 118 to instruct an AGV 114 or other device to transport the determined mobile storage units 218 to a conveyor 244, which may carry the mobile storage units 218 to the carousel station 202. Other methods of bringing the mobile storage units 218 to the carousel station 202 are also possible, as noted elsewhere herein.

At 306, the WES 102 may scan a storage unit 218 using one or more sensors to identify the item(s) at the carousel station 202. For instance, an optical, RFID, or other scanner may be used to confirm the identity of the storage unit on a tote conveyor 244. Accordingly, the identity of items in the mobile storage unit 218 may be confirmed.

At 308, the WES 102 may determine one or more trays or consolidation stations 204 at the carousel station 202 to receive the identified item(s)/order(s). Although trays are referred to in reference to FIG. 3, other configurations of consolidation stations 204 are possible without departing from the scope of this disclosure.

As noted, a tray 204 may be assigned in advance or when a mobile storage unit/tote 218 arrives at the picking location 206 of a carousel station 202. In some implementations, the system (e.g., the WES 102, equipment controller 110, or other components) may determine an empty tray 204 for a new order/item. In some implementations, the system may determine a tray 204 that is already assigned to an order and/or that already holds items for the order into which items may be placed so that multiple SKUs can be placed together into the tray 204. For example, each tray 204 may effectively have a pick list that may be fulfilled using mobile storage units 218 as they arrive.

At 310, the WES 102 may rotate the carousel 212 to move the tray(s) 204 to a picking location 206 accessible to the robotic arm 210, although, as discussed above, other mechanisms for moving items to a tray 204 may be used. For example, the equipment controller(s) 110 may cause a motor coupled with the carousel 212 (e.g., via pulley or gear coupled with a chain or belt) to rotate the carousel 212 and thereby the trays 204.

At 312, the WES 102 may move the item(s) from the identified storage unit into the tray(s) 204 to which they are assigned. For example, the WES 102 or equipment controller(s) 110 may instruct a robotic arm 210 to grasp an item in the mobile storage unit 218, articulate to a picking location 206 at which the tray 204 is located, and place the item in or on the tray 204. The WES 102 may update a file or data entry associated with the order, item, mobile storage unit 218, carousel station 202, and/or tray 204 to reflect that the tray 204 is holding the item, the mobile storage unit 218 is no longer holding the item, and this pick task has been completed.

Where multiple of the same SKU are assigned to be picked to the same tray 204, the robotic arm 210 may pick multiple of the item into the tray 204. In some implementations, such as where multiple mobile storage units 218 are available to the robotic arm 210 (e.g., through range of movement or ability of the tote conveyor 244 to move back and forth), the robotic arm 210 may pick multiple items (e.g., of different SKUs) into the same tray 204 simultaneously (e.g., without rotating the carousel 212).

In some implementations, where multiple trays 204 are assigned to receive the same SKU, the carousel 212 may rotate, so that all of the same SKU from the mobile storage unit 218 are placed in assigned trays 204 and the mobile storage unit 218 may be released or proceed downstream on the conveyor 244. In some instances, the conveyor 244 may move forward and/or backward to allow the mobile storage unit 218 to be used for additional picks/orders.

For example, once all picks for a given SKU are picked into the assigned trays 204, the conveyor may proceed to position the next mobile storage unit 218, so that its SKUs may be picked onto assigned trays 204. This process may iterate until, for instance, one or more of the trays 204 have received all of their picks/items (e.g., where all of the assigned lines in the task list for that order or tray 204 have been fulfilled). It should be noted that a carton 222 or order may receive items from multiple trays 204 or may have other picks or tasks elsewhere in a fulfillment center, so it may be moved backward or forward on the carton conveyor 242 to receive additional picks or other tasks.

At 314, the WES 102 may determine that a given tray 204 is complete, for example, that it has received all items (e.g., of a single or multiple SKUs), is full, or the task is otherwise complete. This determination, for instance, may be based on the WES 102 or equipment controller(s) 110 accessing a file indicating multiple picking tasks and their statuses and determining that they have been completed. In some cases, a weight sensor or computer vision may track items being placed on trays 204 or the total items on a given tray 204 to confirm that the picks have been completed properly.

At 316, the WES 102 may form a carton 222 (whether by a human folding or erecting a carton or an automated box former/erector) and/or transport the carton 222 to a transfer location 208 at the carousel station 202 (e.g., on a carton conveyor 242 under the carousel 212). In some implementations, a carton 222 may be formed and/or placed on a carton conveyor 242 responsive to or in anticipation of a tray 204 being completed. In some implementations, a series of cartons 222 are on the carton conveyor 242, and they are assigned to receive items from a tray 204 based on their size and/or position on the conveyor 242. Accordingly, available cartons 222 may be coordinated with complete trays 204 or trays 204 nearing completion.

In some implementations, multiple carton sizes or configurations may be used at a single carousel station 202. For instance, multiple box formers 232, each forming a different sized box, may be located along the carton conveyor 242, so that various sizes of cartons 222 may be inducted and used at the same carousel station 202. In some instances, different carton sizes may be used at different times/batches, on different carton conveyors 242, or otherwise varied to receive different order sizes.

At 318, the WES 102 may rotate the carousel 212 to position the completed tray 204 at the transfer location 208. For instance, in response to the tray 204 having all items picked to it and/or the carton 222 being positioned at the transfer location 208, the equipment controller(s) 110 may rotate the carousel 212 to position the tray 204 at the transfer location 208. In some implementations, the carousel 212 may include or pass by multiple transfer locations 208, so that multiple trays 204 can be transferred at the same time or so that less rotation of the carousel 212 is required before transferring items. Similarly, multiple robotic arms 210 or picking areas 206 may be used. A location of the carousel 212 and its associated trays 204 may be determined based on a distance that it was rotated and/or based on one or more position sensors. As noted elsewhere herein, a motor may be coupled with a belt, chain, or other loop of material for carousel, though linear or other configurations are also possible and contemplated herein.

At 320, the WES 102 may actuate a transfer mechanism 216 to transfer the item(s) from the tray 204 into the carton 222. For example, the transfer mechanism 216, as described elsewhere herein, may include a pusher that pushes items off a tray 204, a lifting mechanism that tips the tray 204 toward the carton 222 (e.g., guided by a chute or other guide), a trap door, or another mechanism. The pusher, lifting mechanism, or other device may be actuated using a linear actuator, a hydraulic or pneumatic ram, a servo, or other motorized device, for example.

Once the items are transferred into the carton 222, the transfer mechanism 216 may reset, and the WES 102 may update a database to indicate that the items are in the carton 222, release or wipe the data entry(ies) indicating items or orders assigned or held in the tray 204, or perform other operations. For example, the WES 102 may assign the tray 204 to another order. In some instance, the actuation or resetting of the transfer mechanism 216 may be monitored using an optical or contact sensor or, for instance, one or more cameras monitored using software. Similarly, the movement of items from the tray(s) 204 into the carton(s) 222 may also be monitored or verified.

After resetting the transfer mechanism 216, the process may rotate the carousel 212 to pick another item, transfer items from another tray 204, assign another order, or perform other operations.

Once the items have been transferred into the carton 222, other operations may be performed respective to the carton 222. For example, at the transfer location 208 or at another point along the carton conveyor 242, one or more other operations may be performed, such as applying a label, printing and inserting a packing slip, performing quality control operations, closing the carton 222, or otherwise. The carton conveyor 242 may transport the carton 222 away from the transfer location 208 to other downstream operations, finalizing, or shipping. In some implementations, the carton 222 may be tracked through the system using an identifier (e.g., a license plate number, barcode, etc.) on the carton 222 and the shipping label may not be applied until later in the picking process, for example, to allow corrections to be made if quality control fails or there is another error.

FIGS. 4A-7C illustrate various example implementations of carousel stations 202, which may be used, for example, in conjunction or in alternative with the other features and operations described herein.

The carousel station 202 allows items to be picked from mobile storage units 218 or totes 218 and into shipping cartons 222. Because the carousel station 202 includes a plurality of trays or consolidation areas 204, among other features (e.g., multiple conveyors 244 and 242) that may be accessed by a single robotic arm 210 (although other implementations are possible), it provides a buffer, so that system resources can be balanced. For instance, fewer AGVs 114, pickers, or other resources may be used in a fulfillment center where a buffer reduces spikes in their demand.

Additionally, the carousel station(s) 202 allow multi-line orders, such as orders with multiple picks of a SKU and/or of multiple SKUs. For example, a carousel station 202 may have a plurality of consolidation areas/stations/trays 204 each of which is accessible to a picking mechanism, such as a robotic arm 210, and which may receive a plurality of items and hold them as a buffer until they are complete and/or until a carton 222 is ready to receive the items. Accordingly, the carousel station 202 may allow multi-line picks to be staged, which provides numerous benefits, as noted in further detail elsewhere herein.

It should be noted that although certain example implementations are illustrated, variations may be used, such as where different means of transporting cartons 222 or mobile storage units 218 are used, different means of moving items than a robotic arm 210 (e.g., a crane, diverter, etc.), or other changes may be made.

In the depicted examples, the carousel(s) 212 may have several (e.g., 5, 10, 20, etc.) trays or consolidation stations 204 that can receive one or multiple (e.g., 2, 3, 4, 10, etc.) items, depending on their size, which can be varied in different implementations or even at a single carousel 212.

FIGS. 4A-4I illustrate various views of example implementations of a carousel picking station 202. FIG. 4A illustrates a front perspective view of an example implementation of a carousel picking station 202. FIG. 4B illustrates a top-down view of an example implementation of a carousel picking station 202. FIG. 4C illustrates a back perspective view of an example implementation of a carousel picking station 202. FIG. 4D illustrates a back perspective view of an example implementation of a carousel picking station 202 with frames, robotic arms, and other components omitted for purposes of illustration. FIG. 4E illustrates a left side view of an example implementation of a carousel picking station 202. FIG. 4F illustrates a back view of an example implementation of a carousel picking station 202. FIG. 4G illustrates a right view of an example implementation of a carousel picking station 202. FIG. 4H illustrates a front view of an example implementation of a carousel picking station 202. FIG. 4I illustrates a back up view of an example implementation of a carousel picking station 202 with frames, robotic arms, and other components omitted for purposes of illustration. Although FIGS. 4A-4I illustrate various views of an implementation of the carousel picking station 202, others are described and illustrated herein. Some example features are described in in reference to the examples in FIGS. 4A-4I and may refer to any of these figures or, where a specific figure is referenced, to an aspect illustrated in that figure.

Although other configurations are possible, illustrated example configurations are provided. In some figures, certain elements have been omitted from illustration to improve clarity. The features described in reference to the various figures herein may be omitted, changed, interchanged, or augmented without departing from the technology. For instance, aspects of some example implementations may be used with other implementations. Example components of the illustrated carousel station 202 may be described in further detail below in reference to other figures, although various configurations are possible.

As illustrated in FIGS. 4A-4I, components of a carousel station 202 may be held by/within a frame 404 or other structure that holds some of its components and/or keeps a human away from moving parts. For example, as illustrated, the frame 404 may be constructed from aluminum extrusions, although other constructions are possible. In the depicted implementation, the frame 404 may include a door or passthrough 406 via which a human agent may place picks, correct errors, perform maintenance, or clear jams. The passthrough 406 may include a sensor that detects when it is opened or the access window/passage is blocked (e.g., when an agent passes their arm through the passthrough 406), which may cause mechanical operations of the carousel station 202 to cease to avoid injury.

The carousel 212 may include a plurality of trays 204 positioned around its circumference. For example, the carousel 212 may include a chain or belt that moves around a track to push/pull trays 204 along its length and/or around pulleys at its ends. For example, as illustrated, the inner edge of the trays 204 (e.g., toward a center of the carousel 212) may be coupled with the chain, which moves them around the track, although other implementations are possible, such as the trays 204 being coupled at a center, inner edge, outer edge, etc. A tray 204 may include a bottom surface and one or more walls that help keep items from sliding off the tray 204 when it moves around the carousel 212. In some implementations, one edge (e.g., an inner edge toward the center of the carousel 212, as illustrated) of a tray 204 may not include a wall or a portion thereof, so that as the tray 204 is tipped toward that edge, items may more easily slide off. The trays 204 may have various sizes or configurations without departing from the scope of this disclosure.

As illustrated in the example of FIG. 4F, a transfer mechanism 216 may include an electric, pneumatic, or hydraulic rod, ram, or actuator that lifts an edge of the tray 204 (e.g., via a bar, cam, or other structure) to tip the items off the tray 204. For instance, each tray 204 may be hinged at a first edge, when the tray 204 is at a transfer mechanism 216, the transfer mechanism 216 may actuate to lift an edge opposing the first edge thereby causing the tray 204 to tip the items. The station 202 may have one or multiple transfer mechanisms 216. In some implementations, the station 202 may include a chute or other guides adjacent to the transfer mechanism 216, so that items more reliably fall or are transferred into carton(s) 222.

As illustrated in the example, a carton conveyor 242 may be located under a carousel 212, to pass under the transfer location 208. For example, in the example of FIGS. 4A-4I, the carousel 212 may have an open space in the center through which items may be transferred into carton(s) 222 on a carton conveyor 242 below the open space, as noted elsewhere herein. In some implementations, multiple items or all items in an order may be placed into a tray 204 before it is transferred into a carton 222.

The carousel station 202 may include a mobile storage unit 218 receiving location 410 at which a conveyor (e.g., 244—not shown), AGV 114, or other device may place a mobile storage unit 218 and from which a robotic arm 210 may retrieve items. This location 410 may merely be a shelf or table, or it may be another structure or configuration, such as those described and illustrated in the other implementations herein.

In some implementations, at the transfer location 208, such as below a guide, the carousel station 202 may include a label applicator that applies a label to the carton 222, a printer that prints and inserts a packing slip, or other devices. In other implementations, the label applicator, printer, box closer, and other devices may be located along a carton conveyor 242, for example, downstream from the transfer location 208. In some cases, as noted elsewhere herein, the WES 102 may track and/or assign individual cartons 222 based on an identifier (e.g., a barcode, QR code, license plate number, etc.) either before or after an order is assigned to it and/or items in the order are transferred into the carton 222. For instance, the WES 102 may determine that items (some or all) for an order have been consolidated to a tray 204 (or multiple trays, depending on the implementation) and may assign a next carton 222 (e.g., with a certain license plate number) to the order before or after transferring the items into the carton 222.

As illustrated in FIG. 4A, for instance, a carousel station 202 may include a power and/or control unit 412, a carousel motor 414 coupled with the carousel chain or belt via a gear, and other components. For example, as shown in FIG. 4B, a carousel motor 414 may sit above or below a gear that moves the carousel 212 along a track and/or around a second gear at an opposing end of the carousel 212.

Additionally, as shown in the example of FIG. 4B, a storage unit receiving location 410 may be positioned at a along one side (e.g., in front of) the carousel 212 and may include or be adjacent to the carousel 212.

As illustrated in the example of FIG. 4C, in some implementations, a carousel station 202 may include an open, hinged, or transparent panel at a transfer location 208 that allows a camera and/or human agent to view the transfer location 208 and/or mechanism 218 in order to confirm that it is functioning properly and/or remedy errors.

FIG. 4D illustrates the carousel station 202 with various components omitted to show a carousel 212. For instance, FIG. 4D illustrates the trays 204 positioned along a carousel 212. Additionally, FIG. 4D shows an example chute or guide 422 that guides items from a transfer area 208 into a carton 222 below the carousel 212. In some instances, as shown, a carousel 212 may be held on a platform or other structure that provides support for trays 204, a track or guide for a chain or belt of the carousel 212, or other features.

As shown in FIGS. 4E, 4F, 4G, and 4H, in some implementations, a carousel 212 may be positioned at a height approximately between a waist and chest level of a human in order to improve ergonomics for a human performing manual picking or error correcting tasks, although other implementations are possible. Additionally, a height and position of a robotic arm 210, mobile storage unit 218, and tray 204 may be positioned at close proximity to reduce overall movement of the robotic arm 210.

As shown in the examples of FIGS. 4A-4H, a robotic arm 210 include various grasping mechanisms, such as a claw, hand, pneumatic suction cups, and/or other mechanisms to allow the robotic arm 210 to pick up and release items.

FIG. 4I illustrates a bottom-up view of a carousel station 202 with various components removed to expose the carousel 212. For example, as shown, a chain or belt 432 extends around one or more motor driven gears 434a and 434b. The chain or belt may extend around a track or other structure that keeps it in line and/or guides trays 204. In some instances, as illustrated, one or more components, such as a hydraulic or pneumatic ram or linear actuator may be positioned below the carousel 212, although it may be above or beside the carousel 212.

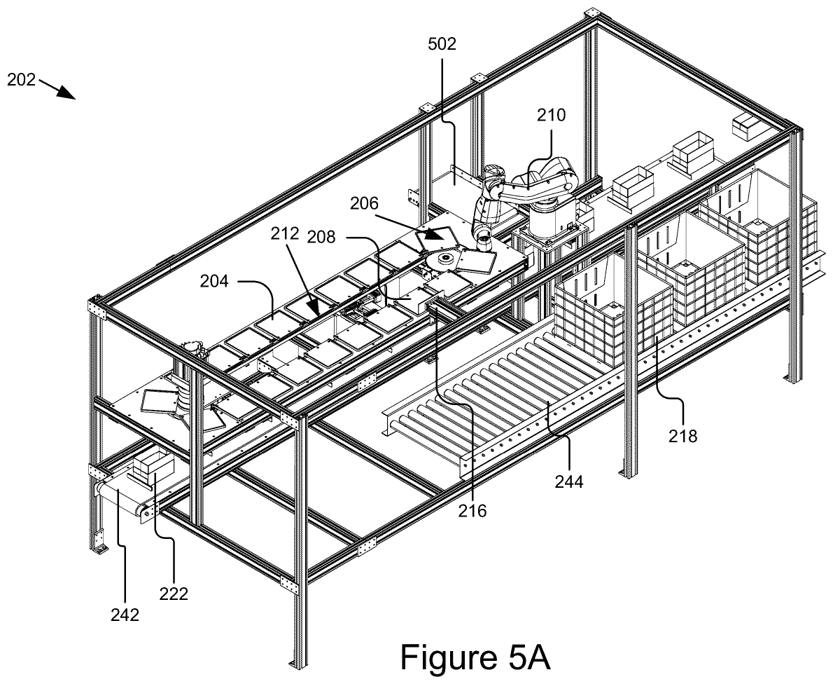

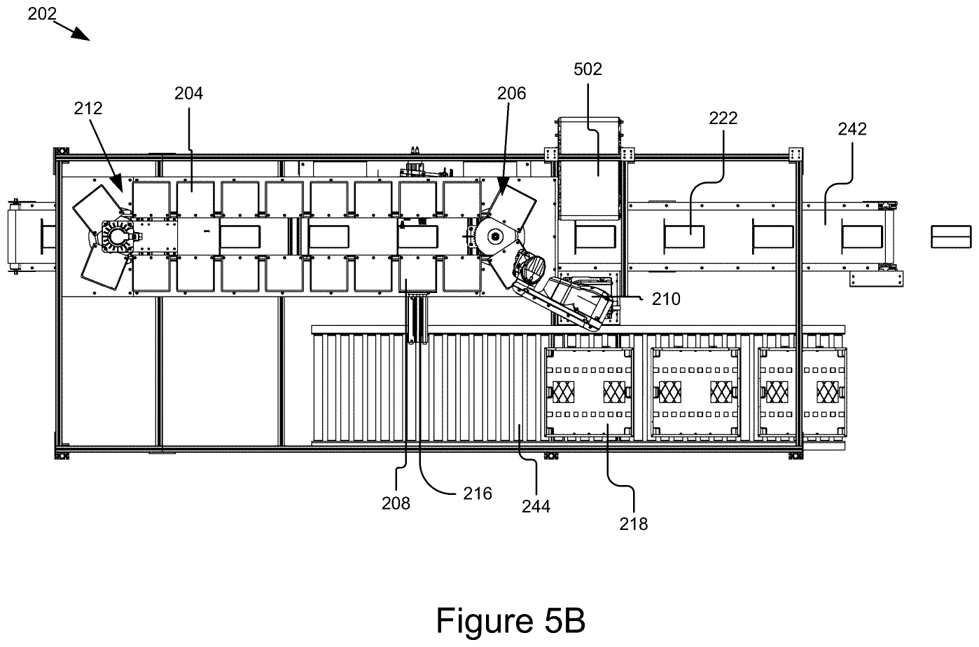

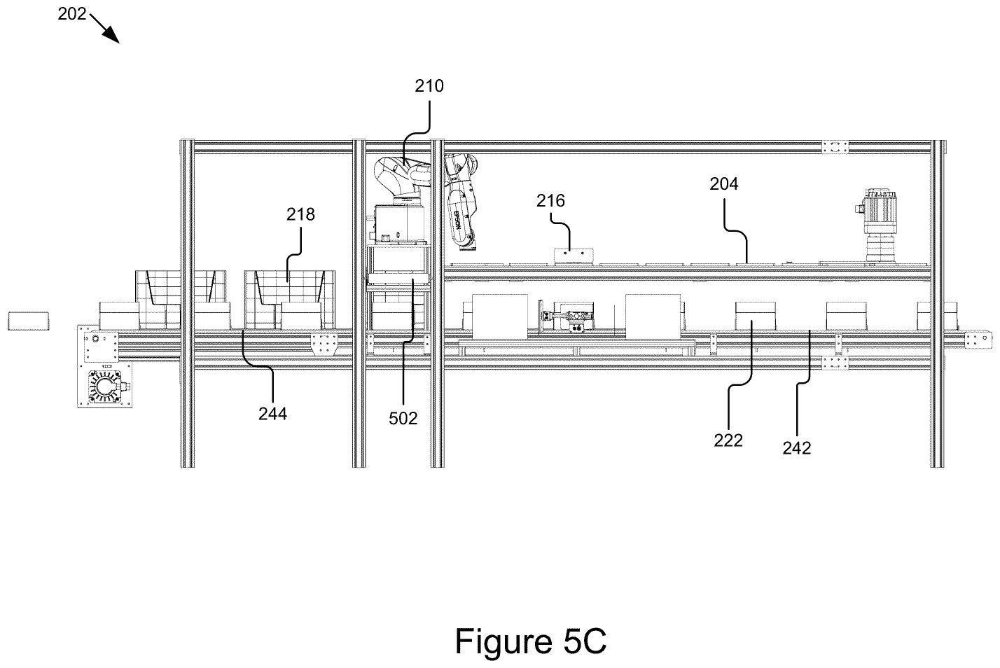

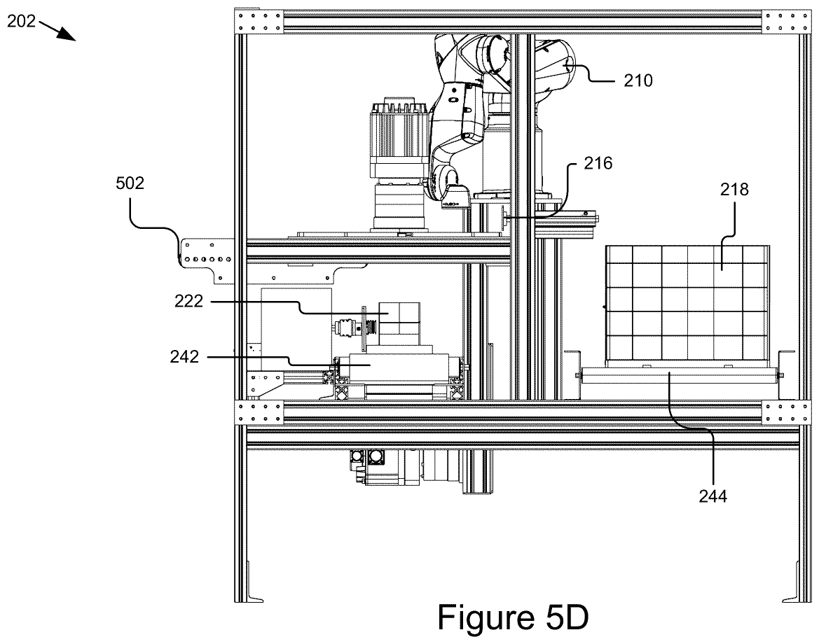

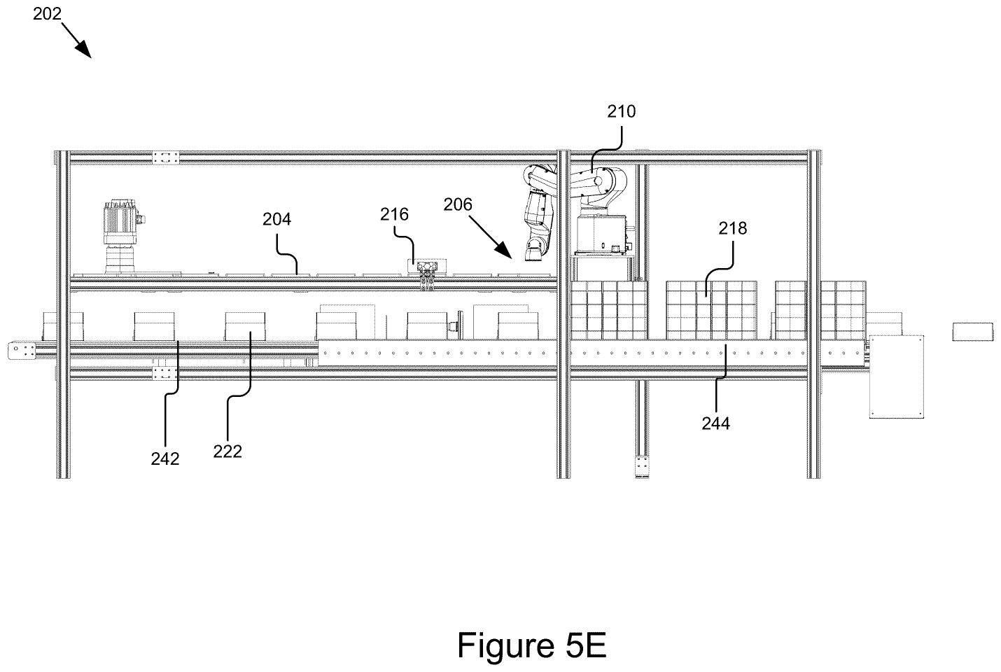

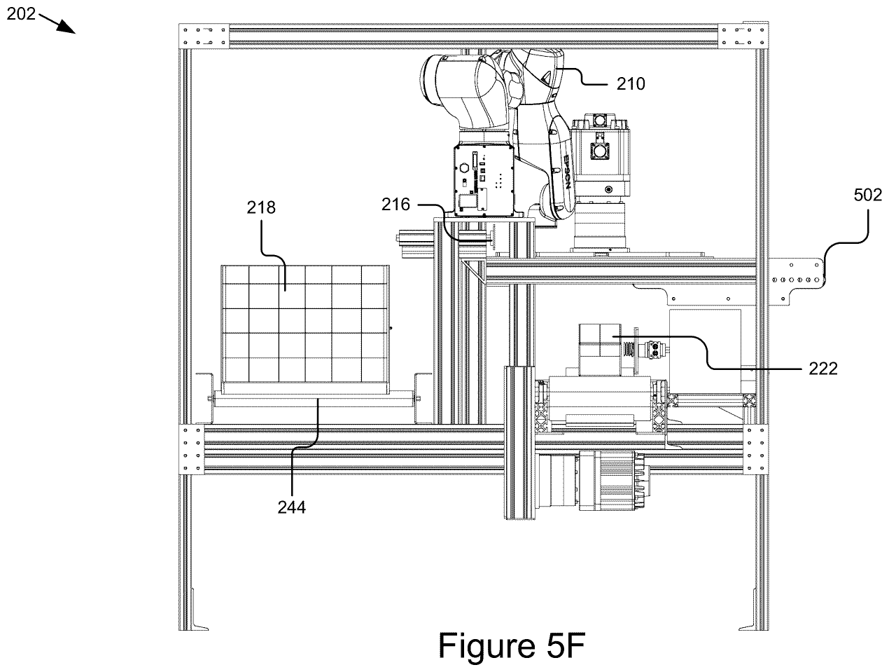

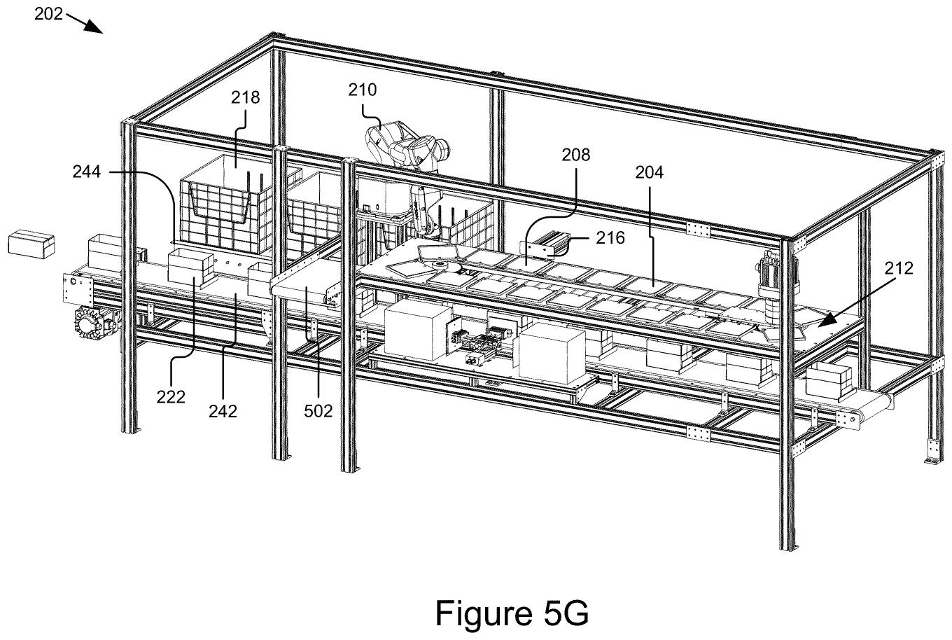

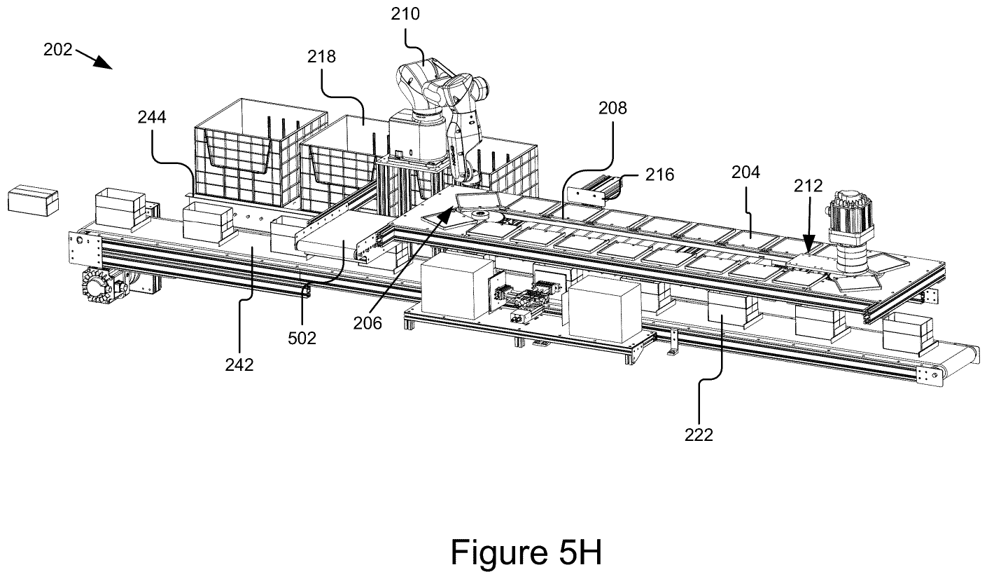

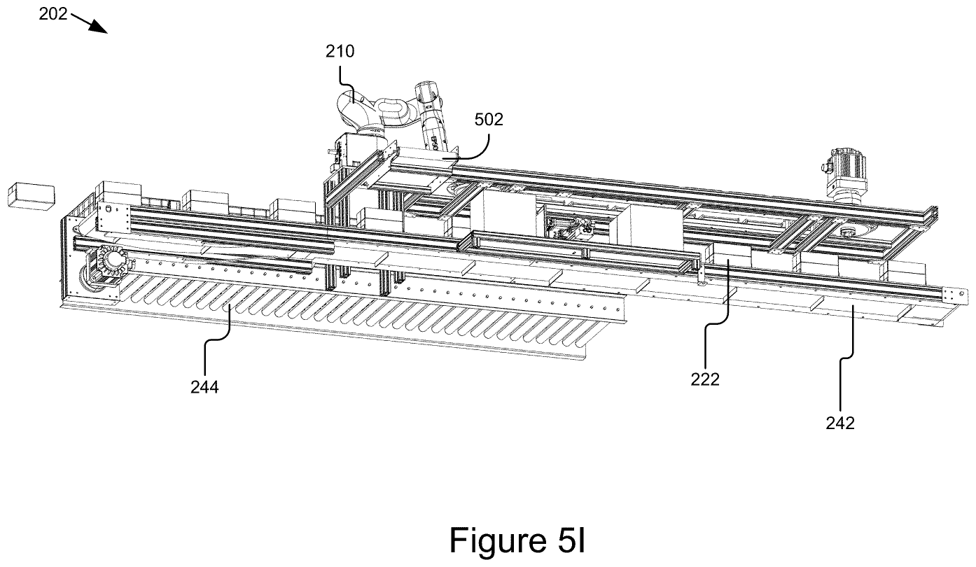

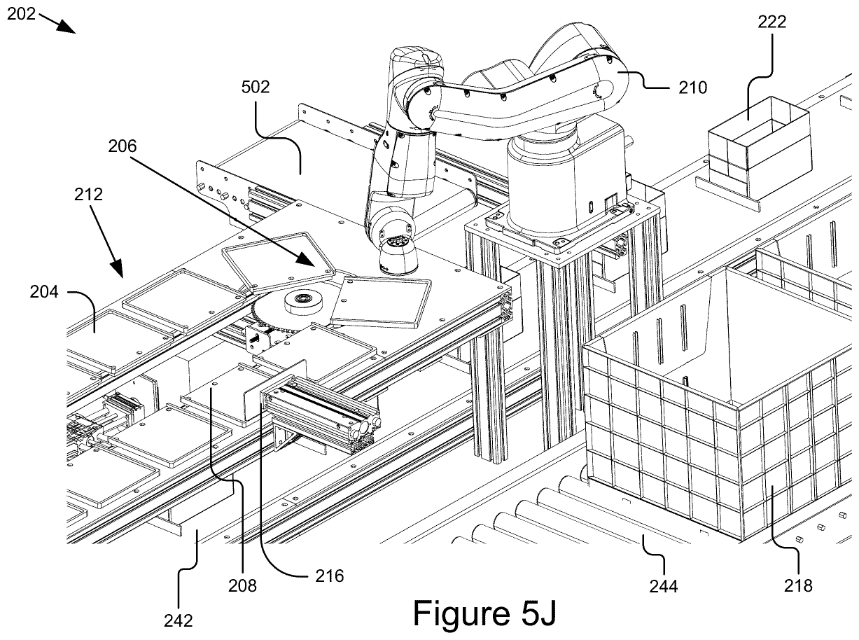

FIGS. 5A-5J illustrate various views of another example implementations of a carousel picking station 202. FIG. 5A illustrates a front perspective view of an example implementation of a carousel picking station 202. FIG. 5B illustrates a top-down view of an example implementation of a carousel picking station 202. FIG. 5C illustrates a back view of an example implementation of a carousel picking station 202. FIG. 5D illustrates a left side view of an example implementation of a carousel picking station 202. FIG. 5E illustrates a front view of an example implementation of a carousel picking station 202. FIG. 5F illustrates a right-side view of an example implementation of a carousel picking station 202. FIG. 5G illustrates a back perspective view of an example implementation of a carousel picking station 202. FIG. 5H illustrates a back perspective view of an example implementation of a carousel picking station 202 with various components omitted for illustration. FIG. 5I illustrates a back bottom-up view of an example implementation of a carousel picking station 202 with various components omitted for illustration. FIG. 5J illustrates a zoomed in detail of a front perspective view of an example implementation of a carousel picking station 202. Although FIGS. 5A-5J illustrate various views of an implementation of the carousel picking station 202, others are described and illustrated herein. Some example features are described in in reference to the examples in FIGS. 5A-5J and may refer to any of these figures or, where a specific figure is referenced, to an aspect illustrated in that figure.

Because many of the components and features of FIGS. 5A-5J are shared with other example implementations herein (e.g., those described above), a repeated discussion of these components may be omitted from the description of these features.

Although other configurations are possible, illustrated example configurations are provided. In some figures, certain elements have been omitted from illustration to improve clarity. The features described in reference to the various figures herein may be omitted, changed, interchanged, or augmented without departing from the technology. The features described in reference to the various figures herein may be omitted, changed, interchanged, or augmented without departing from the technology. For instance, aspects of some example implementations may be used with other implementations described herein.

The carousel station 202 includes a carousel 212 accessible to a robotic arm 210, similar to that of FIG. 4A. In the depicted implementation, a tote conveyor 244 may include rollers that extend along or adjacent to a carousel 212 and to or past a robotic arm 210 to transport mobile storage units 218 to/from the robotic arm 210. It should be noted that although the conveyor 244 is illustrated as extending only partially, it may continue through the carousel station 202 so that mobile storage units 218 may be carried from an upstream location to a downstream location. Although not shown, the upstream or downstream location(s) on the tote conveyor 244 may allow mobile storage units 218 to be placed thereon or retrieved therefrom by a human, AGV 114, crane, forklift, or another device.

In some implementations, as illustrated in the example, a third conveyor 502 may also be located within reach of the robotic arm 210, so that the robotic arm 210 can place items on the third conveyor 502 or retrieve items therefrom. For instance, items that are not in a mobile storage unit 218 may be directly transferred to the picking location 206. In other instances, the robotic arm 210 may pick items from mobile storage units 218 and onto the third conveyor 502, which may transport the items away from the carousel picking station 202 (e.g., to quality control, a sorting mechanism, another carton 222, or otherwise).

As illustrated in the example, a transfer mechanism 216 may include a horizontally mounted pusher that pushes items horizontally off a tray 204 (noting that, as elsewhere herein, not all trays 204 are labeled) at a transfer location 208.

As illustrated in the example of FIG. 5A-5J, a tote conveyor 244 may run parallel to a carton conveyor 242 and at a similar height, though the tote conveyor 244 may be higher, for instance, to place the height of items in mobile storage units 218 within reach of a robotic arm 210. In the example, the robotic arm 210 may be positioned between the tote conveyor 244 and the carton conveyor 242 and, for example, near an end of the carousel 212. The tote conveyor 242 may, depending on the implementation, move in either direction to move items to or from the robotic arm 210 as items are picked from the mobile storage units 218.

FIG. 5J illustrates a detailed, zoomed-in view of an example carousel picking station 202. As shown, the robotic arm 210 is positioned on a pedestal and within reach of one or multiple mobile storage units 218 on a tote conveyor 244. In the example, the picking location 206 may allow the robotic arm 210 to pick items into multiple trays 204 as they are positioned at or pass by the picking location 206.

As illustrated, the trays 204 may have shorter walls, for example, where a tray 204 includes a flat bottom with three short walls. The transfer mechanism 216 may include a horizontally positioned linear actuator pushing a plate or other pushing surface to sweep items at a transfer location 208 into a carton 222, which may be positioned on a carton conveyor 242.

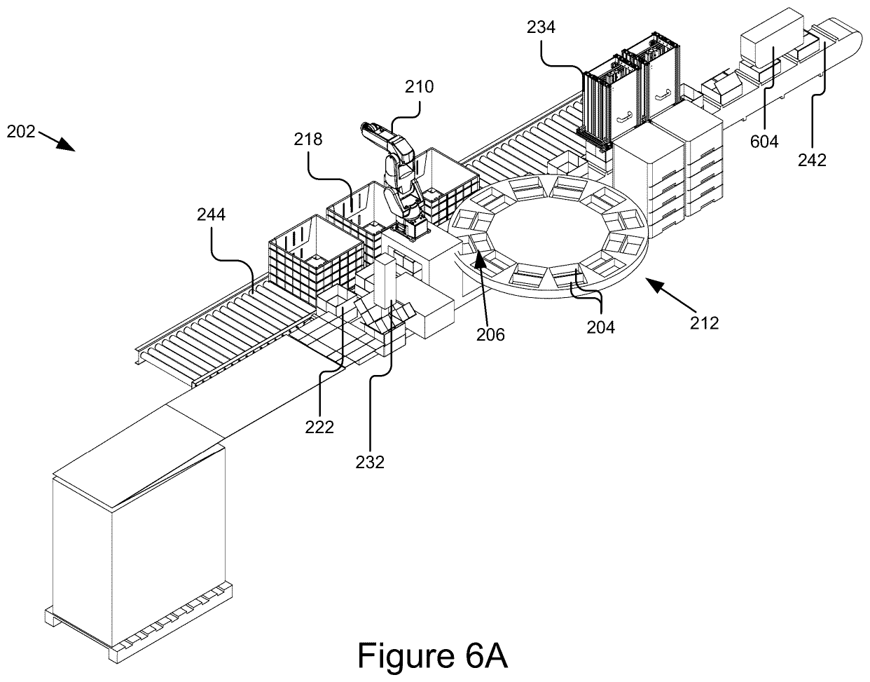

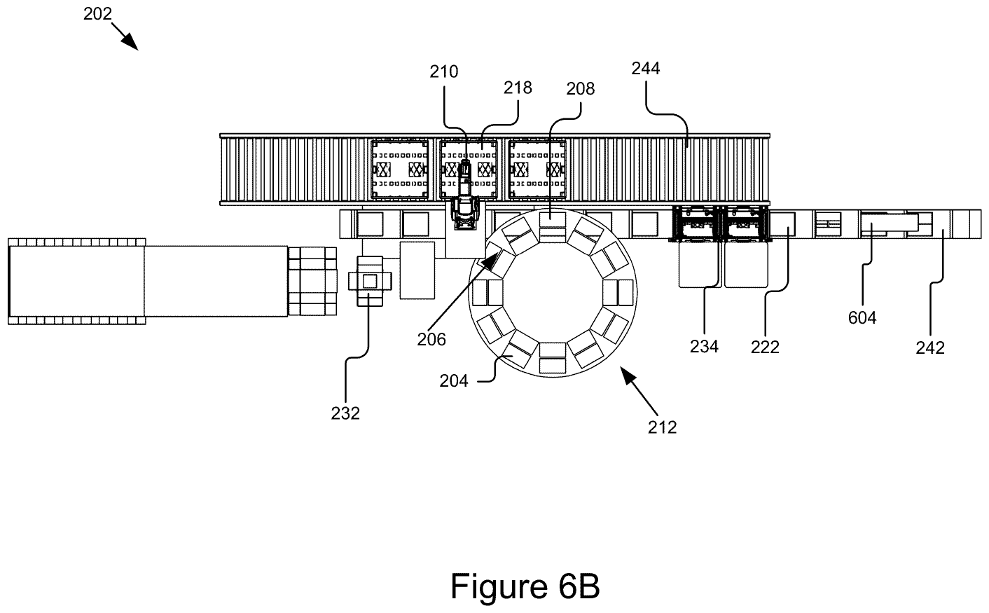

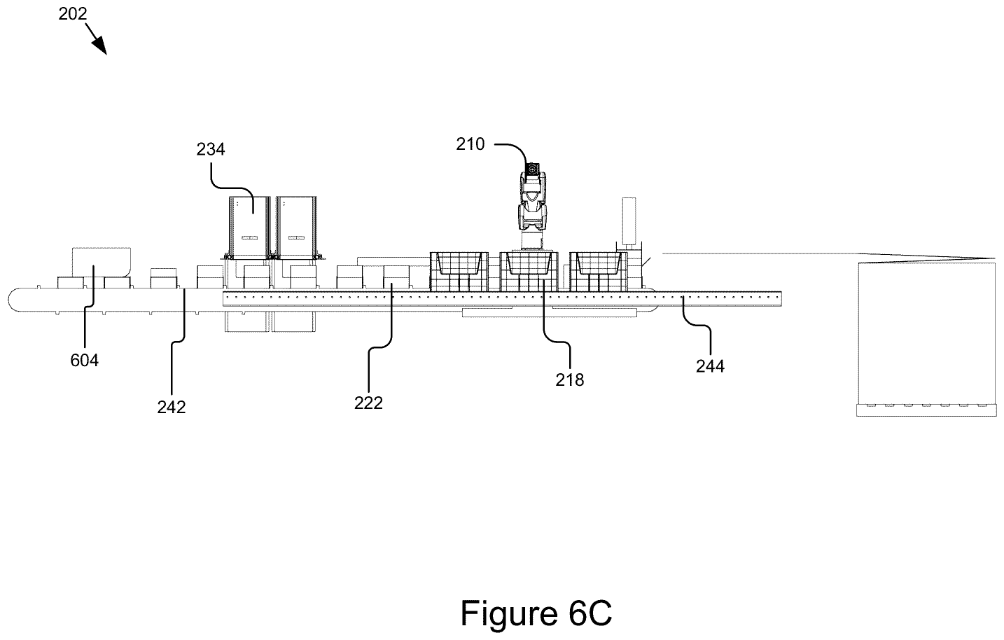

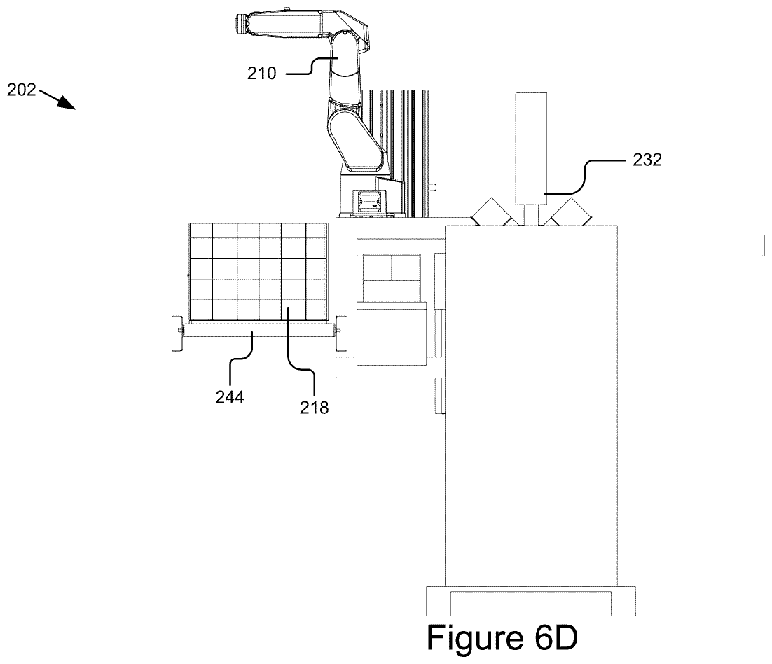

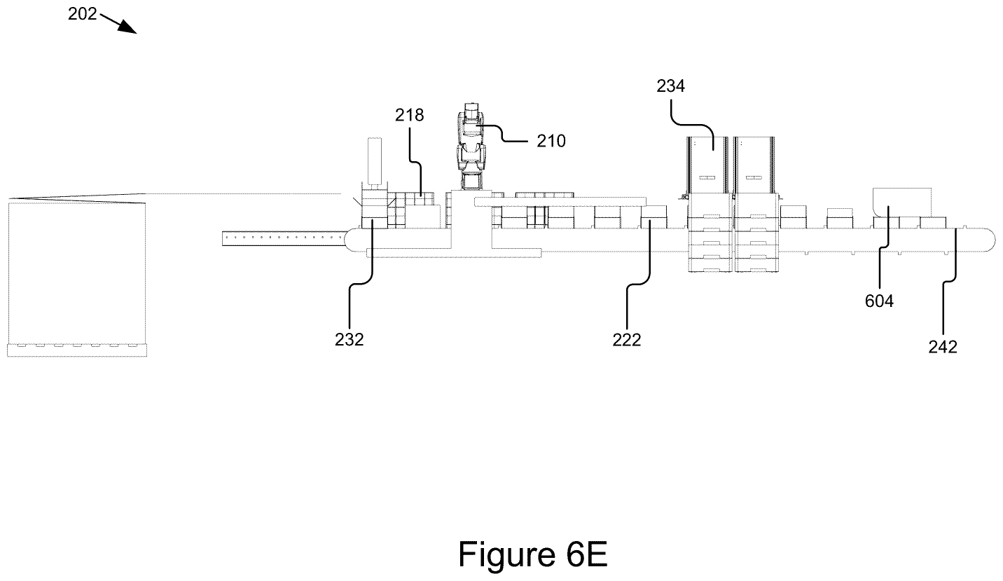

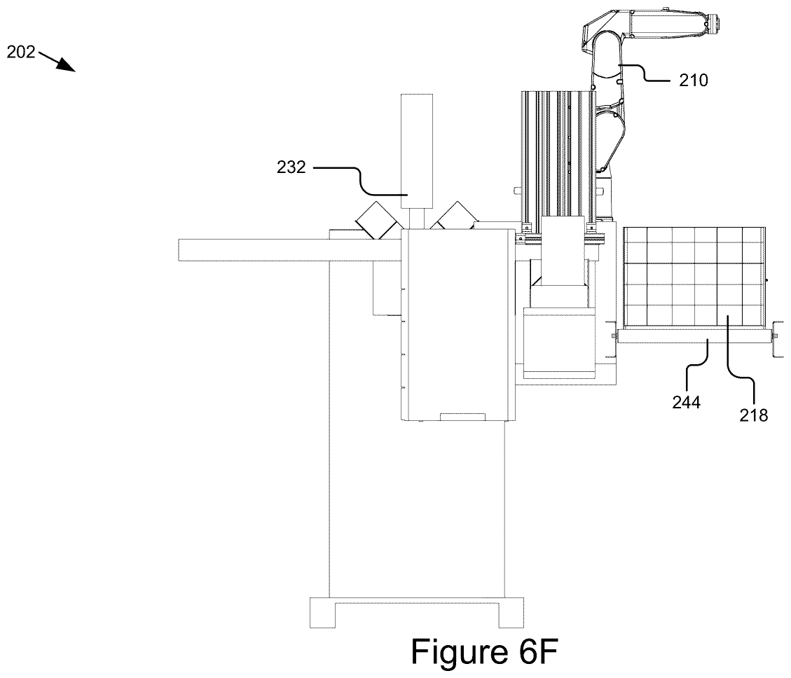

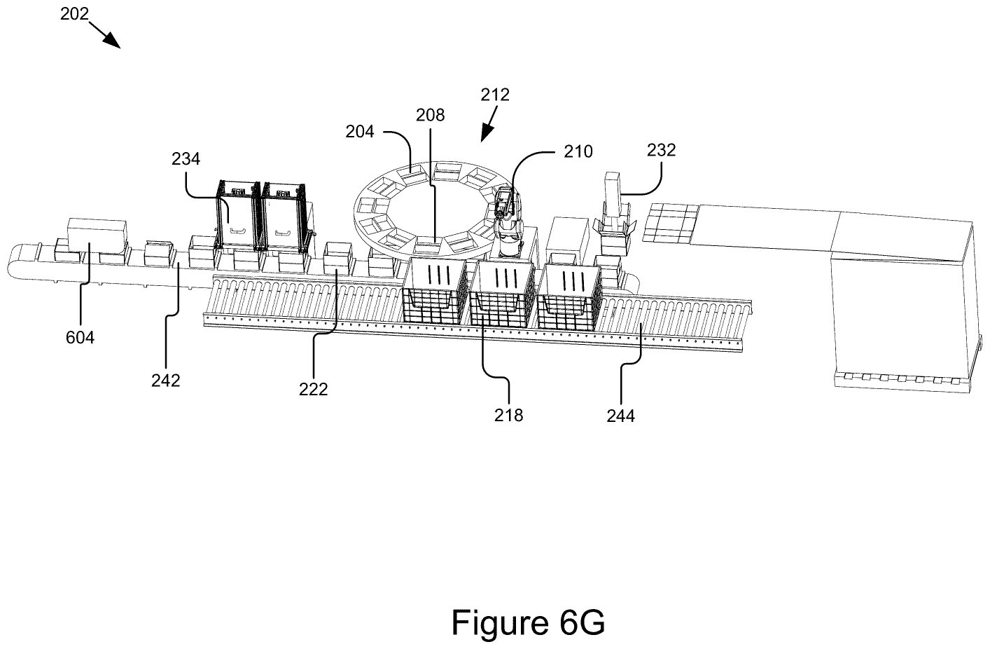

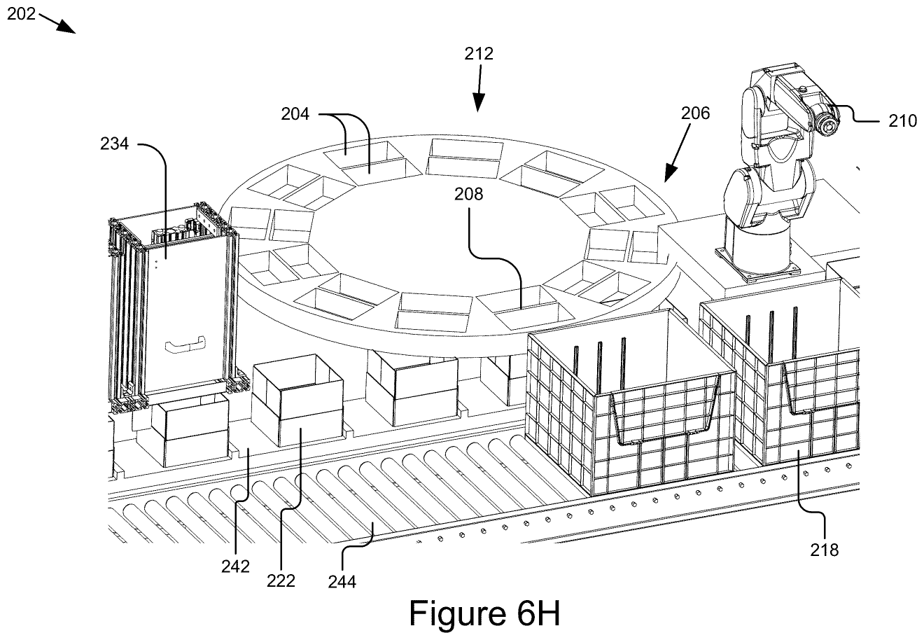

FIGS. 6A-6H illustrate various views of another example implementation of a carousel picking station 202. FIG. 6A illustrates a back perspective view of an example implementation of a carousel picking station 202. FIG. 6B illustrates a top-down view of an example implementation of a carousel picking station 202. FIG. 6C illustrates a front view of an example implementation of a carousel picking station 202. FIG. 6D illustrates a right-side view of an example implementation of a carousel picking station 202. FIG. 6E illustrates a back view of an example implementation of a carousel picking station 202. FIG. 6F illustrates a left-side view of an example implementation of a carousel picking station 202. FIG. 6G illustrates a front perspective view of an example implementation of a carousel picking station 202. FIG. 6H illustrates a zoomed-in front perspective view of an example implementation of a carousel picking station 202. Although FIGS. 6A-6H illustrate various views of an implementation of the carousel picking station 202, others are described and illustrated herein. Some example features are described in in reference to the examples in FIGS. 6A-6H and may refer to any of these figures or, where a specific figure is referenced, to an aspect illustrated in that figure.

Because many of the components and features of FIGS. 6A-6H are shared with other example implementations herein (e.g., those described above), a repeated discussion of these components may be omitted from the description of these features.

Although other configurations are possible, illustrated example configurations are provided. In some figures, certain elements have been omitted from illustration to improve clarity. The features described in reference to the various figures herein may be omitted, changed, interchanged, or augmented without departing from the technology. The features described in reference to the various figures herein may be omitted, changed, interchanged, or augmented without departing from the technology. For instance, aspects of some example implementations may be used with other implementations described herein.

As illustrated in the example, a carousel 212 may be circular and include deeper consolidation stations/trays 204, although other shapes and configurations are possible. The carousel 212 may be a rigid platform that rotates to position trays 204 at a picking location 206 or transfer location 208. In the depicted example, two radially oriented rows of trays 204 may be included, which increases the available quantity of trays 204 and, therefore, orders simultaneously picked and/or consolidated.

In some implementations, the trays 204 may have an opening (e.g., a sliding or trap door) at a bottom, which may be opened or closed to serve as a transfer mechanism 216 and allow items to pass therethrough into a carton. As illustrated, a carton conveyor 242 may pass under the carousel 212 to allow items to be dropped through and into the carton(s) 222.

In the depicted implementation, a box former 232 is at a first end of a carton conveyor 242, which passes by a carousel 212. Although a plunger-style box former 232 is shown plunging carton blanks through guides to form a carton 222, other implementations are possible. In some cases, after a carton 222 is formed, it may pass a shipping label applicator, which applies labels to formed cartons. The carton conveyor 242 may convey the cartons 222 past a carousel 212 to receive items from tray(s) 204. The carton conveyor 242 then passes other components 234, such as one or more printers, label applicators, and box closers. For example, the other component 234 may include a print-and-pack mechanism that prints a packing slip into a carton 222. The cartons 222 may then pass a box closer 604 that closes and seals cartons 222 to prepare them for shipping, for instance. Other sequences and operations for preparing, picking, and completing cartons 222 are also contemplated.

As shown in the example, a tote conveyor 244 may be located parallel with the carton conveyor 242 to convey mobile storage units 218 past a robotic arm 210, so that the robotic arm 210 may transfer items from a mobile storage unit 218 into a consolidation station/tray 204 of a carousel 212, which then consolidates items and/or transfers them to a shipping carton 222.

As shown in the example of FIGS. 6A-6H, a robotic arm 210 may be positioned within reach of both trays 204 and one or more cartons 222 (e.g., the robotic arm 210 is shown above and adjacent to a carton conveyor 242), so that the robotic arm 210 may place items into either a tray 204 or directly into a carton 222.

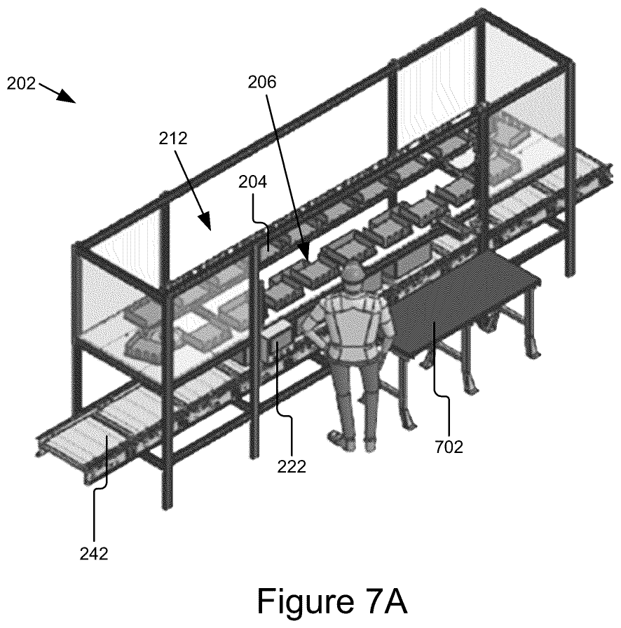

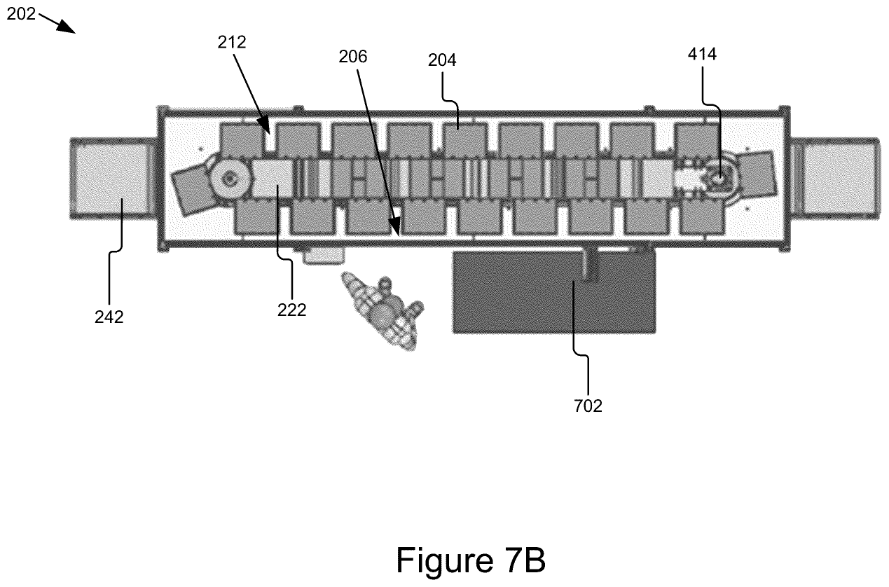

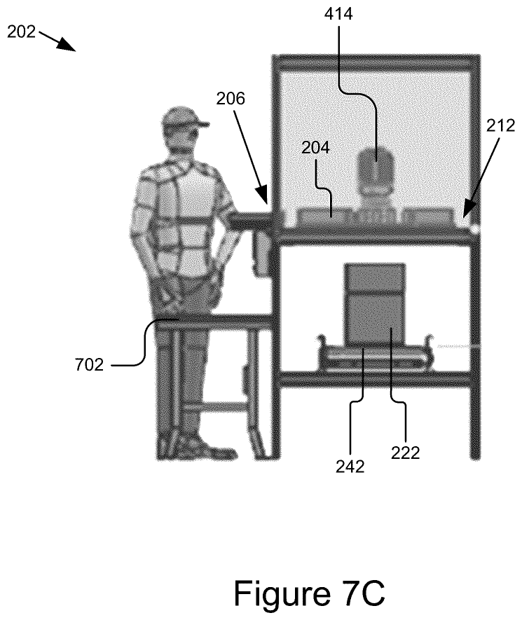

FIGS. 7A-7C illustrate various views of an example implementation of a carousel picking station 202, according to some implementations. FIG. 7A illustrates a front perspective view of an example implementation of a carousel picking station 202. FIG. 7B illustrates a top-down view of an example implementation of a carousel picking station 202. FIG. 7C illustrates a right-side view of an example implementation of a carousel picking station 202. Although FIGS. 7A-7C illustrate various views of an implementation of the carousel picking station 202, others are described and illustrated herein. Some example features are described in in reference to the examples in FIGS. 7A-7C and may refer to any of these figures or, where a specific figure is referenced, to an aspect illustrated in that figure.

Because many of the components and features of FIGS. 7A-7C are shared with other example implementations herein (e.g., those described above), a repeated discussion of these components may be omitted from the description of these features. As noted elsewhere herein, the described and/or illustrated features may be combined or interchanged with any other operations or features herein. Similarly, the features or operations may be omitted, reordered, augmented, or otherwise modified. FIGS. 7A-7C illustrate example dimensions and components, although other implementations are possible and contemplated, although other implementations are possible and contemplated.

As illustrated in the examples of FIGS. 7A-7C, various views of a human activated carousel station 202 are shown. For example, in lieu (or in addition to) a robotic device (e.g., a robotic arm 210) a human agent or humanoid robot may pick items onto trays 204 of a carousel 212. For instance, a table 702 or other receiving locations for mobile storage units 218 may be positioned adjacent to a window at a picking location 206 through which a human picker may place items onto trays 204. The carousel 212 may be manually rotated by a user (whether through physical force or actuating the illustrated motor 414) or may be automatically rotated as items are placed thereon (e.g., after the picker's arms/hands are removed from the window).

For example, in a similar way to a WES 102 or equipment controller(s) 110 instructing a robotic arm 210, the human interface system 108 may instruct the user (e.g., via audio cues, graphical user interfaces, lights, or other output devices) to perform tasks, such as picking defined items into defined trays 204, and receive confirmations of tasks. Responsive to confirmation of task completion, the WES 102 or equipment controller(s) 110 may rotate the carousel 212, actuate a transfer mechanism 216, or perform other operations.

In some implementations, one or more of the operations and features of the example carousel station 202 in FIGS. 7A-7C may be initiated manually by the agent.

Various measurements, shapes, configurations, features, details, or other attributes are possible and contemplated. For instance, a carousel picking station 202, such as that illustrated in FIGS. 7A-7C, may have an overall height (e.g., above a floor) of approximately seven feet, the trays 204 may have a height of four feet, and a carton conveyor 242 may have a height of two feet. Similarly, the carousel may have a width of two to four feet and a length of fifteen to twenty feet. Many other sizes and configurations are possible and contemplated herein.

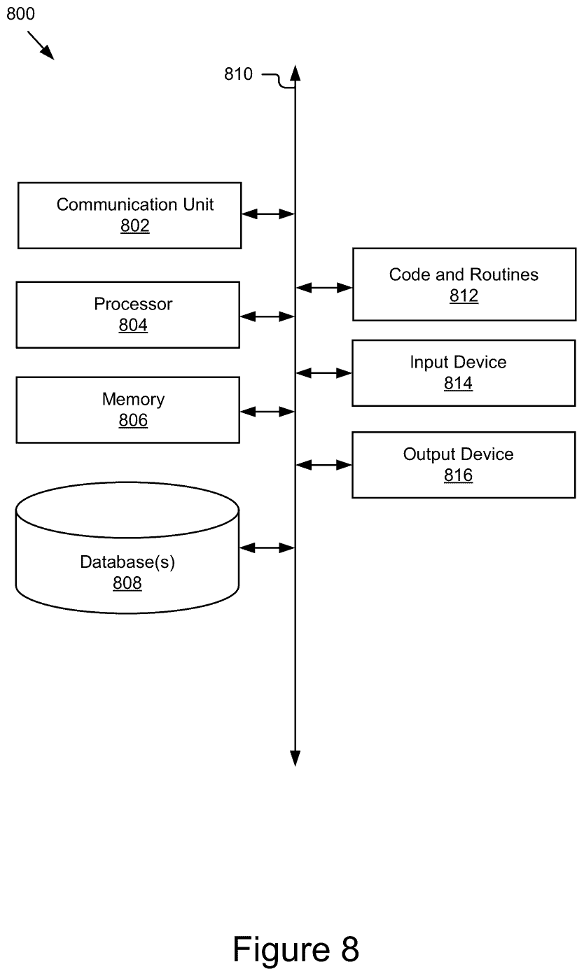

FIG. 8 is a block diagram illustrating an example computing system 800. The example computing system 800 may correspond to a WES 102, a WMS 104, a dispatch system 106, a human interface system 108, equipment controller(s) 110, REX server 118, a client device, a computing device of a carousel station 202, a computing device of a robotic arm 210, or other component of the system 100, for example.

The code and routines 812 may include computer logic executable by the processor 804 on a computing system 800 to provide for the functionality described in reference to the system 100. For instance, in some implementations, the code and routines may include one or more of the components of the WES 102, equipment controller(s) 110, or other system(s) for controlling the carousel station 202 and/or components thereof.

As depicted, the computing system 800 may include a processor 804, a memory 806, a communication unit 802, an output device 816, an input device 814, and database(s) 808, which may be communicatively coupled by a communication bus 810. The computing system 800 depicted in FIG. 8 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc.

While not shown, the computing system 800 may include various operating systems, sensors, additional processors, and other physical configurations. Although, for purposes of clarity, FIG. 8 only shows a single processor 804, memory 806, communication unit 802, etc., it should be understood that the computing system 800 may include a plurality of one or more of these components.

The processor 804 may execute software instructions by performing various input, logical, and/or mathematical operations. The processor 804 may have various computing architectures to process data signals including, for example, a complex instruction set computer (CISC) architecture, a reduced instruction set computer (RISC) architecture, and/or an architecture implementing a combination of instruction sets. The processor 804 may be physical and/or virtual, and it may include a single core or plurality of processing units and/or cores. In some implementations, the processor 804 may be capable of generating and providing electronic display signals to a display device, supporting the display of images, capturing and transmitting images, performing complex tasks including various types of feature extraction and sampling, etc. In some implementations, the processor 804 may be coupled to the memory 806 via the bus 810 to access data and instructions therefrom and store data therein. The bus 810 may couple the processor 804 to the other components of the computing system 800 including, for example, the memory 806, the communication unit 802, the input device 814, the output device 816, and the database(s) 808.

The memory 806 may store and provide access to data to the other components of the computing system 800. The memory 806 may be included in a single computing device or a plurality of computing devices. In some implementations, the memory 806 may store instructions and/or data that may be executed by the processor 804. For example, the memory 806 may store the code and routines 812. The memory 806 is also capable of storing other instructions and data, including, for example, an operating system, hardware drivers, other software applications, databases, etc. The memory 806 may be coupled to the bus 810 for communication with the processor 804 and the other components of computing system 800.

The memory 806 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 804. In some implementations, the memory 806 may include one or more of volatile memory and non-volatile memory (e.g., RAM, ROM, hard disk, optical disk, etc.). It should be understood that the memory 806 may be a single device or may include multiple types of devices and configurations.

The bus 810 can include a communication bus for transferring data between components of a computing device or between computing devices, a network bus system including a network or portions thereof, a processor mesh, a combination thereof, etc. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 802 may include one or more interface devices (I/F) for wired and wireless connectivity among the components of the system 100. For instance, the communication unit 802 may include various types of connectivity and interface options. The communication unit 802 may be coupled to the other components of the computing system 800 via the bus 810. The communication unit 802 may be electronically communicatively coupled to a network (e.g., wiredly, wirelessly, etc.). In some implementations, the communication unit 802 can link the processor 804 to a network, which may in turn be coupled to other processing systems. The communication unit 802 can provide other connections to a network and to other entities of the system 100 using various standard communication protocols.

The input device 814 may include any device for inputting information into the computing system 800. In some implementations, the input device 814 may include one or more peripheral devices. For example, the input device 814 may include a keyboard, a pointing device, microphone, an image/video capture device (e.g., camera), a touchscreen display integrated with the output device 816, optical scanner, barcode reader, QR™ code reader, RFID (radio-frequency identification) tag reader, etc.

The output device 816 may be any device capable of outputting information from the computing system 800. The output device 816 may include one or more of a display (LCD, OLED, etc.), a printer, a 3D printer, a haptic device, audio reproduction device, touch-screen display, etc. In some implementations, the output device is a display which may display electronic images and data output by the computing system 800 for presentation to a user, such as a picker or associate in the order fulfillment center. In some implementations, the computing system 800 may include a graphics adapter (not shown) for rendering and outputting the images and data for presentation on output device 816. The graphics adapter (not shown) may be a separate processing device including a separate processor and memory (not shown) or may be integrated with the processor 804 and memory 806.

The database(s) are information source(s) for storing and providing access to data. The data stored by the database(s) 808 may be organized and queried using various criteria including any type of data stored by them, such as the data in the data store 120 and other data discussed herein. The database(s) 808 may include file systems, data tables, documents, databases, or other organized collections of data. Examples of the types of data stored by the database(s) 808 may include the data described herein, for example, in reference to the data store 120.

The database(s) 808 may be included in the computing system 800 or in another computing system and/or storage system distinct from but coupled to or accessible by the computing system 800. The database(s) 808 can include one or more non-transitory computer-readable mediums for storing the data. In some implementations, the database(s) 808 may be incorporated with the memory 806 or may be distinct therefrom. In some implementations, the database(s) 808 may store data associated with a database management system (DBMS) operable on the computing system 800. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

It should be noted that the components described herein may be further delineated or changed without departing from the techniques described herein. For example, the processes described throughout this disclosure may be performed by fewer, additional, or different components.

It should be understood that the methods described herein are provided by way of example, and that variations and combinations of these methods, as well as other methods, are contemplated. For example, in some implementations, at least a portion of one or more of the methods represent various segments of one or more larger methods and may be concatenated or various steps of these methods may be combined to produce other methods which are encompassed by the present disclosure. Additionally, it should be understood that various operations in the methods are iterative, and thus repeated as many times as necessary generate the results described herein. Further the ordering of the operations in the methods is provided by way of example and it should be understood that various operations may occur earlier and/or later in the method without departing from the scope thereof.

In the above description, for purposes of explanation, numerous specific details are set forth in order to provide a thorough understanding of the present disclosure. However, it should be understood that the technology described herein can be practiced without these specific details in various cases. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms such as “processing,” “computing,” “calculating,” “determining,” “displaying,” or the like, refer to the action and methods of a computer system that manipulates and transforms data represented as physical (electronic) quantities within the computer system's registers and memories into other data similarly represented as physical quantities within the computer system memories or registers or other such information storage, transmission or display devices.

A data processing system suitable for storing and/or executing program code, such as the computing system and/or devices discussed herein, may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices can be coupled to the system either directly or through intervening I/O controllers. The data processing system may include an apparatus may be specially constructed for the required purposes, or it may comprise a general-purpose computer selectively activated or reconfigured by a computer program stored in the computer.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects may not be mandatory or significant, and the mechanisms that implement the specification or its features may have different names, divisions, and/or formats.

Furthermore, the modules, routines, features, attributes, methodologies, and other aspects of the disclosure can be implemented as software, hardware, firmware, or any combination of the foregoing. The technology can also take the form of a computer program product accessible from a computer-usable or computer-readable medium providing program code for use by or in connection with a computer or any instruction execution system. Wherever a component, an example of which is a module or engine, of the specification is implemented as software, the component can be implemented as a standalone program, as part of a larger program, as a plurality of separate programs, as a statically or dynamically linked library, as a kernel loadable module, as firmware, as resident software, as microcode, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A system comprising:
a plurality of consolidation stations and a carousel moving the plurality of consolidation stations past a picking location, one or more consolidation stations of the plurality of consolidation stations receiving one or more items at the picking location;
a first transportation mechanism adapted to bring one or more cartons to the picking location at the carousel;
a robotic arm articulating to move the one or more items from one or more mobile storage units into the one or more consolidation stations at the picking location; and
a transfer mechanism adapted to transfer items from the one or more consolidation stations into the one or more cartons.

2. The system of claim 1, further comprising:
a motor coupled with the carousel that causes the carousel to rotate and position the one or more consolidation stations at one or more of the picking location and a transfer location.

3. The system of claim 1, wherein:
each of the one or more consolidation stations include a bottom surface and three walls, the transfer mechanism interacting the consolidation station to move the one or more items into the one or more cartons.

4. The system of claim 1, wherein:
the transfer mechanism is located at a stationary point along the carousel, the transfer mechanism causing the one or more items in the one or more consolidation stations to fall through a chute and into the one or more cartons held by the first transportation mechanism.

5. The system of claim 1, wherein:
each of the one or more consolidation stations include a tray that is adapted to pivot upwards to place a bottom surface of the tray at an angle to horizontal and cause the one or more items to slide off the bottom surface; and
the transfer mechanism is adapted to lift an edge of the tray upwards to place the bottom surface at the angle.

6. The system of claim 1, wherein:
the transfer mechanism includes a pushing mechanism that translates horizontally to push the one or more items horizontally off of the one or more consolidation stations.

7. The system of claim 1, wherein:
the transfer mechanism includes one or more doors at a bottom of the one or more consolidation stations, the transfer mechanism opening the one or more doors to cause the one or more items to fall into the one or more cartons.

8. The system of claim 1, wherein:
the first transportation mechanism includes a conveyor passing under the carousel, the one or more cartons remaining on the conveyor when the one or more items are transferred into the one or more cartons.

9. The system of claim 1, further comprising:
a second transportation mechanism adapted to bring the one or more mobile storage units to a receiving area accessible to the robotic arm, the one or more mobile storage units holding the one or more items when the one or more mobile storage units are transported on the second transportation mechanism.

10. The system of claim 9, wherein:
the second transportation mechanism includes a conveyor, the conveyor carrying the one or more mobile storage units to the picking location and within reach of the robotic arm.

11. A method comprising:
transporting one or more storage units holding one or more items to a carousel, the carousel including one or more consolidation stations;
transferring one or more first items of the one or more items from a first storage unit of the one or more storage units into a first consolidation station of the one or more consolidation stations at the carousel;
rotating the carousel by a first distance to position the first consolidation station at a transfer location; and
transferring the one or more first items from the first consolidation station into a carton.

12. The method of claim 11, wherein:
rotating the carousel includes moving a plurality of consolidation stations around a loop.

13. The method of claim 11, wherein:
transporting the one or more storage units to the carousel includes causing a conveyor holding the one or more storage units to move until the one or more storage units are within reach of a robotic arm; and
transferring the one or more first items to the first consolidation station includes articulating the robotic arm to move the one or more first items from the one or more storage units to the first consolidation station.

14. The method of claim 11, further comprising:
consolidating the one or more first items and one or more second items into the first consolidation station prior to transferring the one or more first items from the first consolidation station into the carton, the one or more second items being transferred with the one or more first items into the carton.

15. The method of claim 11, further comprising:
transferring the one or more first items into a plurality of consolidation stations including transferring a first set of the one or more first items into the first consolidation station, rotating the carousel, and transferring a second set of the one or more first items into a second consolidation station.

16. The method of claim 11, further comprising:
transporting the carton to the transfer location at the carousel using a conveyor; and
transporting the carton away from the carousel using the conveyor after the one or more first items have been transferred from the first consolidation station into the carton.

17. The method of claim 11, further comprising:
assigning a first order and second order to be automatically picked at the carousel, the first order and the second order including the one or more first items;
assigning the first consolidation station to the first order, the first consolidation station receiving items in the first order including a first set of the one or more first items; and
assigning a second consolidation station to the second order, the second consolidation station receiving items in the second order including a second set of the one or more first items, the carousel including the first consolidation station and the second consolidation station.

18. The method of claim 11, wherein:
transferring the one or more first items from the first consolidation station into the carton is responsive to determining that all items in an order assigned to the first consolidation station have been consolidated into the first consolidation station.

19. The method of claim 11, wherein:
rotating the carousel includes rotating a motor coupled with the carousel until the first consolidation station is at one or more of the transfer location and a picking location; and
transferring the one or more first items from the first consolidation station includes electronically actuating a transfer mechanism that causes the one or more first items to be moved from the first consolidation station into the carton.

20. A system comprising:
a plurality of consolidation stations around a carousel that moves one or more of the plurality of consolidation stations to a picking location, the one or more consolidation stations receiving one or more items at the picking location;
a first transportation mechanism adapted to bring one or more cartons to the picking location at the carousel;
a robotic arm adapted to move the one or more items from one or more mobile storage units into the one or more consolidation stations at the picking location;
a transfer mechanism at a transfer location and adapted to transfer the one or more items from the one or more consolidation stations into the one or more cartons; and
one or more processors that perform operations including:
instructing the robotic arm to transfer the one or more items from the one or more mobile storage units into the one or more consolidation stations at the picking location;
instructing a motor coupled with the carousel to rotate the carousel by a first distance to position the one or more consolidation stations at the transfer location; and
instructing the transfer mechanism to transfer the one or more items from the one or more consolidation stations into the one or more cartons.
